(19) United States
(12) Patent Application Publication
(10) Pub. No.: US 2026/0037791 A1
(43) Pub. Date: Feb. 5, 2026

(54) HARDWARE-EMBEDDED NEURAL NETWORK WITH OPTIMIZED ACTIVATION FUNCTION

(71) Applicant: Intel Corporation, Santa Clara, CA (US)

(72) Inventors: Yaron Klein, Rosh Haayin (IL); Yoni Elron, Hadera (IL); Avi Salmon, Kiriat Ata (IL); Simon Rubanovich, Haifa (IL); Yuval Vered, Tel-Aviv (IL)

(73) Assignee: Intel Corporation, Santa Clara, CA (US)

(21) Appl. No.: 19/353,362

(22) Filed: Oct. 8, 2025

Related U.S. Application Data
(60) Provisional application No. 63/734,501, filed on Dec. 16, 2024.

(51) Int. Cl. G06N 3/063

(52) U.S. Cl. CPC G06N 3/063

(57) ABSTRACT

An integrated circuit (IC) device may implement a deep neural network (DNN). The IC device may include an activator unit that implements a nonlinear activation function in the DNN. The nonlinear activation function may be decomposed into a rectified linear unit (ReLU) function and a symmetric function. After receiving an input value, the activator unit may apply the ReLU function on the input value to compute a first value. The input range of the nonlinear activation function may be partitioned into segments. The activator unit may determine which segment the input value falls into. The activator unit may apply a linear function, which approximates the symmetric function within the segment, on the input value to compute a second value. The activator unit may correct an error in the second value and compute an output of the nonlinear activation function based on the first value and the second value.

### CROSS-REFERENCE TO RELATED APPLICATION

This application claims the benefit of U.S. Provisional Patent Application No. 63/734,501, filed Dec. 16, 2024, and titled “HARDWARE-EMBEDDED NEURAL NETWORK WITH OPTIMIZED ACTIVATION FUNCTION,” which is incorporated by reference in its entirety for all purposes.

### TECHNICAL FIELD

This disclosure relates generally to artificial intelligence (AI), and more specifically, hardware-embedded neural networks (also referred to as “deep neural networks” or “DNNs”) with optimized activation functions.

### BACKGROUND

DNNs are used extensively for a variety of AI applications ranging from natural language processing to computer vision, speech recognition, and image processing due to their ability to achieve high accuracy. However, the high accuracy comes at the expense of significant computation cost. DNNs have extremely high computing demands as there can be a large number of operations as well as a large amount of data to read and write. Therefore, techniques to improve efficiency of DNNs are needed.

### BRIEF DESCRIPTION OF THE DRAWINGS

Embodiments can be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an integrated circuit (IC) device that implements a model on silicon, in accordance with various embodiments.

FIG. 2 illustrates an inference process of a DNN model, in accordance with various embodiments.

FIG. 3 illustrates a sigmoid linear unit (SiLU) activation function, in accordance with various embodiments.

FIG. 4 illustrates a rectified linear unit (ReLU) function, in accordance with various embodiments.

FIG. 5 illustrates a symmetric function, in accordance with various embodiments.

FIG. 6 illustrates a process of a hardware device computing a symmetric function, in accordance with various embodiments.

FIG. 7 illustrates segmenting a SiLU activation function, in accordance with various embodiments.

FIG. 8 illustrates linear approximation of a SiLU activation function, in accordance with various embodiments.

FIG. 9 illustrates a process of approximating a SiLU activation function, in accordance with various embodiments.

FIG. 10 illustrates a process of segmentation and range selection, in accordance with various embodiments, in accordance with various embodiments.

FIG. 11 illustrates linear approximation of a symmetric function, in accordance with various embodiments.

FIG. 12 illustrates another linear approximation of a symmetric function, in accordance with various embodiments.

FIG. 13 illustrates an embedding dot unit, in accordance with various embodiments.

FIG. 14 illustrates a sequential read-only memory (ROM), in accordance with various embodiments.

FIG. 15 illustrates an attention multiplier, in accordance with various embodiments.

FIG. 16 is a flowchart showing a method of executing a nonlinear activation function, in accordance with various embodiments.

FIG. 17 illustrates an example transformer model, in accordance with various embodiments.

FIG. 18 illustrates the first inference process of a transformer model, in accordance with various embodiments.

FIG. 19 illustrates subsequent inference processes of the transformer model, in accordance with various embodiments.

FIG. 20 is a block diagram of an example computing device, in accordance with various embodiments.

### DETAILED DESCRIPTION

The last decade has witnessed a rapid rise in AI based data processing, particularly based on neural networks (also referred to as deep neural networks (DNNs)). DNNs are widely used in various domains (e.g., language processing, computer vision, speech recognition, autonomous driving, image processing, video processing, etc.) mainly due to their ability to achieve beyond human-level accuracy. A DNN typically includes a sequence of layers. A DNN layer may include one or more deep learning operations (also referred to as “neural network operations”), such as embedding operation, MatMul operation, layer normalization, batch normalization, activator operations (e.g., SiLU operation, SoftMax operation, etc.), pooling, elementwise operation, linear operation, nonlinear operation, and so on.

Neural network operations may be tensor operations. Input or output data of neural network operations may be arranged in data structures called tensors. Taking a convolutional layer for example, the input tensors include an activation tensor (also referred to as “input feature map (IFM)” or “input activation tensor”) including one or more activations (also referred to as “input elements”) and a weight tensor. The weight tensor may be a kernel (a 2D weight tensor), a filter (a 3D weight tensor), or a group of filters (a 4D weight tensor). A convolution may be performed on the input activation tensor and weight tensor to compute an output activation tensor in the convolutional layer.

A tensor is a data structure having multiple elements across one or more dimensions. Examples of tensors include vector (which is one-dimensional (1D) tensor), matrix (which is two-dimensional (2D) tensor), 3D tensors, four-dimensional (4D) tensors, and even higher dimensional tensors. A dimension of a tensor may correspond to an axis, e.g., an axis in a coordinate system. A dimension may be measured by the number of data points along the axis. The dimensions of a tensor may define the shape of the tensor. A DNN layer may receive one or more input tensors and compute an output tensor from the one or more input tensors. In some embodiments, a 3D tensor may have an X-dimension, a Y-dimension, and Z-dimension. The X-dimension of a tensor may be the horizontal dimension, the length of which may be the width of the tensor; the Y-dimension may be the vertical dimension, the length of which may be the height of the tensor; and the Z-dimension may be the channel dimension, the length of which may be the number of channels. The coordinates of the elements along a dimension may be integers in an inclusive range from 0 to (L−1), where L is the length of the tensor in the dimension. For instance, the x coordinate of the first element in a row may be 0, the x coordinate of the second element in a row may be 1, and so on. Similarly, the y coordinate of the first element in a column may be 0, the y coordinate of the second element in a column may be 1, and so on. A 4D tensor may have a fourth dimension, which may indicate the number of batches in the operation.

Deployment and execution of many complex DNN models are carried out on high-performance graphics processing units (GPUs). While GPUs can provide the computational horsepower needed to handle these sophisticated models, they come with significant drawbacks, including high power consumption and latency issues. These limitations become especially problematic in environments where real-time processing and power efficiency are critical, such as in mobile devices, edge computing, and Internet of Things (IOT) applications.

A crucial aspect of many complex models is the use of activation functions, which introduce nonlinearity into the model and allow it to learn from data more effectively. Activation functions, such as ReLU, sigmoid, and tanh, are essential for many DNNs because they help the model capture intricate patterns and relationships within the data. Without these functions, the model would essentially reduce to a linear function, losing its ability to handle complex tasks. However, executing activation functions usually requires significant computational resources. Even though some activation functions, like ReLU, are relatively simple to compute, others, like sigmoid and tanh, involve more complex mathematical operations that demand considerable processing power. This need for computation contributes to the overall latency and power consumption of the model.

To mitigate these challenges, ROM look-up tables are used to store precomputed values of activation functions. While this approach can speed up the computation, it introduces other inefficiencies. Look-up tables typically require memory storage, and accessing these tables involves memory operations, which can still be relatively slow and consume power. Furthermore, the use of look-up tables can also necessitate additional logic to handle the indexing and retrieval of values, adding to the overall complexity and resource requirements.

While activation functions are indispensable for the performance and accuracy of neural networks, their computation can demand significant resources, whether through direct calculation or look-up tables. These requirements, combined with the inherent inefficiencies in current model implementation methodologies, contribute to high power consumption and latency issues encountered in deploying machine learning models on GPUs.

A solution employed in chip design involves using separate sequential ROMs to store look-up tables of activation functions. These ROMs can hold the precomputed values needed for the activation functions, while distinct multipliers and tree adders processed this data. However, this approach typically requires significant memory to store the data in ROM. Consequently, this can lead to inefficiencies due to the substantial power overhead introduced by the memory needed.

Typically, activation functions are computed directly on GPUs or central processing units (CPUs) by calculating the mathematical operations, such as the exponential function for sigmoid or tanh. While GPUs/CPUs can provide the computational power to handle these calculations, this method introduces several inefficiencies. Calculating functions like the exponential can be computationally intensive and require significant processing power, which can lead to increased power consumption and latency. Furthermore, since GPUs do not perform computations within their memory, data frequently shuttles between memory and compute units. This can result in high-bandwidth transactions that are both power-intensive and time-consuming, especially for complex models. Additionally, the general-purpose nature of GPUs means they are typically not optimized for specific tasks like DNN inference, making them less efficient for dedicated tasks such as computing activation functions in pretrained models.

Embodiments of this disclosure may improve on at least some of the challenges and issues described above by embedding DNNs on IC devices (e.g., a silicon die or chip) that includes optimized activation function units. In an example, an IC device implementing a DNN model may include an activator unit that can efficiently implement an activation function in the DNN, such as SiLU activation function, in hardware. Computation of the activation function can be reduced by the use of linear function, symmetric function, segmentation and range selection, linear approximation, or some combination thereof.

In various embodiments of this disclosure, a DNN is embedded onto an IC device. The IC device may implement the model architecture and internal parameters (e.g., weights) of the DNN. The IC device may include an activator unit that implements a nonlinear activation function in the DNN. The nonlinear activation function may be a SiLU activation function. The nonlinear activation function may be decomposed into a ReLU function and a symmetric function. The symmetric function may be a SiLU−ReLU function. After receiving an input value, the activator unit may apply the ReLU function on the input value to compute a first value. The activator unit may also use linear functions to approximate the symmetric function. The input range of the nonlinear activation function may be partitioned into segments. Each segment may have a particular linear function that approximates the symmetric function with the segment. The activator unit may determine which segment the input value falls into, e.g., based on an exponent or mantissa of the input value. In an example where in the input value is a FP16 value, the FP 16 input may be segmented based on its 5-bit exponent, resulting in 32 possible exponent ranges. Each exponent range may be subdivided into 16 segments based on the 10-bit mantissa. Within each segment, linear approximations can be used to model the SiLU function using FP8 coefficients and biases, minimizing memory usage. The activator unit may retrieve parameters of the linear function (“linear parameters”) corresponding to the segment. The linear parameters may include coefficient/slope and bias/intercept. The linear parameters may be precomputed and stored in a memory, such as a sequential ROM. The activator unit may apply the linear function on the input value to compute a second value. The activator unit may compute an output value of the nonlinear activation function based on the first value and the second value. The output value may be a sum of the first value and the second value.

The activator unit can also exploit the symmetry of activation functions to simplify calculations by computing values for positive inputs and mirroring these for negative inputs. The function is further simplified by isolating the symmetric component, the SiLU−ReLU function, reducing computational complexity. In some implementations, the activator unit may also correct an error in the linear approximation. The error may represent a difference between the linear function and the actual symmetric function within the segment. Error corrections may be accessed and applied to the initial linear approximation to produce the final output. For positive inputs, the final SiLU value may be computed by adding the corrected approximation to the ReLU result, while for negative inputs, symmetry may be utilized to mirror the positive results. For instance, the activator unit may modify the second value based on an error correction value and compute the final output value of the SiLU activation function from the first value and the modified second value. The error correction value may be precomputed and stored in the memory for efficient retrieval. Such corrections may be applied to the linear approximations to enhance accuracy.

The approach in this disclosure can significantly reduce computational complexity and hardware resource requirements, making it highly efficient for real-time applications. The segmentation and linear approximation strategy can ensure scalability and flexibility, allowing for adjustable accuracy based on specific application needs. This approach can achieve a balance between computational efficiency and accuracy, making it well-suited for hardware implementations of neural networks where resources are limited. The use of linear parameters (e.g., FP8 coefficients and biases) and ROM-stored error corrections can further optimize memory usage and simplify hardware design. The power efficiency and performance improvements offered by the approach in this disclosure can make it ideal for edge computing, mobile, and IoT applications where resources are constrained and low latency is critical. By eliminating the need for extensive routing and reducing data movement, the integrated design of IC devices in this disclosure can support real-time computing requirements more effectively. This makes the solution highly suitable for time-sensitive applications, ensuring quick and efficient processing of computational tasks.

For purposes of explanation, specific numbers, materials and configurations are set forth in order to provide a thorough understanding of the illustrative implementations. However, it can be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations are described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

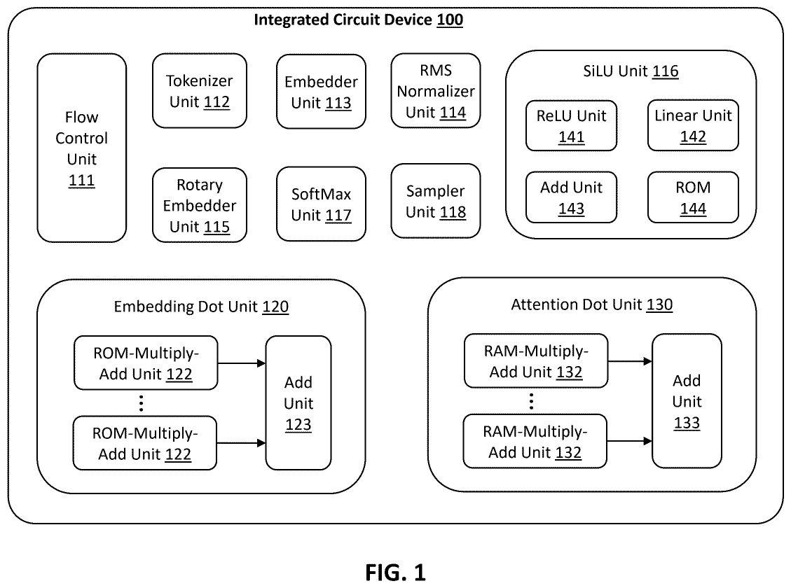

FIG. 1 illustrates an IC device 100 that implements a model on silicon, in accordance with various embodiments. In some embodiments, the IC device 100 may be a hardware implementation of a DNN, such as a transformer-based model. An example of the DNN is a large language model (LLM). At least part of the model architecture, weights, and flow of the DNN can be embedded into the IC device 100. For instance, the IC device 100 may include memories that store the weights of the DNN. The IC device 100 may also include compute units that are mapped to the operators in the DNN. In some embodiments, the IC device 100 may be a chip, such as a silicon chip.

As shown in FIG. 1, the IC device 100 includes a flow control unit 111, tokenizer unit 112, embedder unit 113, root mean square (RMS) normalizer unit 114, rotary embedder unit 115, SiLU unit 116, SoftMax unit 117, sampler unit 118, embedding dot unit 120, and attention dot unit 130. A unit in the IC device 100 may be a circuit or may include multiple circuits. In other embodiments, the IC device 100 may include fewer, more, or different components. For example, the base die 110 may include more than one flow control unit 111, tokenizer unit 112, embedder unit 113, RMS normalizer unit 114, rotary embedder unit 115, SiLU unit 116, SoftMax unit 117, sampler unit 118, embedding dot unit 120, or attention dot unit 130. As another example, the units may be arranged in fewer, more, or different dies of the IC device 100. Further, functionality attributed to a component of IC device 100 may be accomplished by a different component included in the IC device 100 or a different device.

The flow control unit 111 manages data flow between various components of the IC device 100. In some embodiments, the flow control unit 111 plays a role in orchestrating various components (e.g., units) of the IC device 100 to execute operations according to a predetermined timing sequence. The flow control unit 111 may also be referred to as a sequencer unit, which can orchestrate one or more other components of the IC device 100 according to a predetermined timing sequence of the DNN. In an example, the flow control unit 111 may control and ensure that the tokenizer unit 112 converts input tokens and passes them to the embedding sections, such as the embedder unit 113, the rotary embedder unit 115, and embedding dot unit 120; the embeddings are then processed and passed to the attention dot unit 130 for attention computation; the attention results are then normalized by the RMS normalizer unit 114, activated by the SiLU unit 116, and passed through the SoftMax unit 117 to generate output probabilities; finally, the sampler unit 118 samples from the output distribution and generates the final output tokens.

In some embodiments, the DNN operates in a feedforward manner. In an example, the DNN may include a sequence of layers. A layer may have one or more operators. For a layer having multiple operators, the operators may be arranged in the sequence. Each operator may correspond to a neural network operation. For example, a MatMul operator specifies a MatMul operation. The sequence of all the operators in the DNN may be predetermined as a part of the model architecture of the DNN. In some embodiments, the spatial shape of the input tensor(s) and output tensor of an operator can also be predetermined. During inference, data flows through the operators in the DNN in the predetermined sequence. The predetermined sequence of the operators in the DNN can be mapped into a timing sequence of various components of the IC device 100 executing the corresponding neural network operations. The timing sequence of neural network operations may include stages of operations, one following another. In a particular time slot or stage in the timing sequence, data can be moved in, processed, and moved out to be processed in the next/following time slot, in a feedforward, progressive manner.

In some embodiments, the flow control unit 111 may implement digital logic to generate clock edges/signals (e.g., control signals, timing signals, enable signals, disable signals, trigger signals, etc.) to orchestrate operations to be performed according to the timing sequence. The flow control unit 111 may control data flow into or out of one or more other components of the IC device 100. The flow control unit 111 may also enable or disable one or more other components of the IC device 100 according to a predetermined timing sequence.

The tokenizer unit 112 is a hardware implementation of a tokenizer in the DNN. In an example, the tokenizer unit 112 is a hardware-based tokenizer for a DNN. The tokenizer unit 112 may convert raw data (e.g., words) to tokens. For instance, the tokenizer unit 112 may use the DNN's vocabulary to convert works received from a user to tokens that can be further processed by other operators in the DNN. The vocabulary may be predefined vocabulary. In some embodiments, the vocabulary of the DNN is implemented on the tokenizer unit 112. For instance, the vocabulary may be stored in a data storage unit of the tokenizer unit 112. The tokenizer unit 112, after receiving words, may compare the words with the vocabulary to determine indices of tokens corresponding to the words. The tokenizer unit 112 may output the token indices.

In some embodiments, the tokenizer unit 112 includes a cycle buffer, comparator, memory, ID block, and multiplexer (MUX). The cycle buffer may receive and store data received by the tokenizer unit 112. The data may be the input data of the DNN. The input data may be one or more words that need to be tokenized. In some embodiments, the tokenizer unit 112 may have a different type of data storage unit from the cycle buffer for storing input data. The comparator retrieves input data from the cycle buffer and compares the word(s) with the vocabulary of the DNN. The vocabulary of the DNN is stored in the memory. The memory may be a ROM, such as a sequential ROM. The memory may store a list of vocabulary entries, which are predefined words or tokens. Each vocabulary entry corresponds to a unique Token ID. The ID block stores the Token IDs associated with each vocabulary entry. When the comparator finds a match in the vocabulary, the ID block receives the corresponding Token ID. After a Token ID is retrieved, it is output through the ID block. The comparator may access the vocabulary in the memory to find a match for each word in the input data. When a match is found, the corresponding Token ID is fetched from the ID block and provided to the MUX. The MUX may output the Token ID as an output of the tokenizer unit 112. In some embodiments, the output of the Token ID from the MUX may be controlled by a signal from the comparator. The signal may indicate that a match has been found.

The embedder unit 113 may implement an embedder (e.g., an embedding layer) of the DNN. The embedder unit 113 may execute the embedding layer to convert tokens (such as tokens generated by and received from the tokenizer unit 112) to embedding vectors. In some embodiments, the embedder unit 113 may include look-up tables that map tokens to embedding elements. The look-up tables may output embedding elements corresponding to input tokens. The embedding elements may constitute the embedding vector of the input tokens.

In an example, the embedder unit 113 includes 256 look-up tables. The look-up tables may have the same storage size, e.g., 1000 KB. Each of the look-up tables may have 112,000 lines. In some embodiments, the look-up tables may be implemented on one or more ROMs. In an example, the 256 look-up tables are implemented on 256 ROMs, respectively. The embedder unit 113 may receive an input token. In the example shown in FIG. 1, the embedder unit 113 receives an input token represented by 15 bits. The input token may have an integer format. The embedder unit 113 may also receive control signals. For instance, the embedder unit 113 receives an embedder cycle signal, which may have 10 bits. The embedder unit 113 also receives an embedder run signal, which may have 1 bit. The embedder unit 113 may also receive an embedder on/off signal, which may have 1 bit.

The output of the embedder unit 113 may be an embedding vector. For instance, the embedder unit 113 may produce an embedding vector with floating-point (e.g., FP16) data elements. The dimension of the embedding vector may indicate the total number of data elements in the embedding vector. In an example, the dimension of the embedding vector may be 10,096. In some embodiments, the embedder unit 113 may receive 32,000 tokens. The total embedder size may be 250 MB, which equals 10,096×32,000×2B. Each of the tokens in the vocabulary may be broken into 16 chunks of 256 numbers. In some embodiments (e.g., embodiments where the look-up tables are stored in ROMs), the first out of 16 numbers may be read from the table. Reading from the ROM may be sequential for 16 cycles, so the next line is to be pre-charged but it may be unnecessary to pre-charge other lines. Within each cycle, the 256 look-up tables may output 256 embedding vector elements, respectively. The embedder unit 113 may return 256 elements every clock cycle for 16 clocks cycles. After finishing the 16 cycles, the embedder unit 113 may be idle for about 10,000 cycles. Power gating may be used.

The RMS normalizer unit 114 may normalize data using RMS normalization. The RMS normalizer unit 114 may implement one or more RMS normalizer functions in the DNN. An RMS normalizer function may be denoted as:

$$\frac{{x}_{i} \cdot {W}_{R M {S}_{i}}}{\sqrt{\frac{{\sum }_{j = 0}^{4 , 096} {x}_{j}^{2}}{4 , 096} + {10}^{- 5}}}$$

In some embodiments, the RMS normalizer unit 114 may receive an input vector (e.g., 4096 FP16 elements) and return an RMS-normalized vector (e.g., 4096 elements in FP8 format). The RMS normalizer unit 114 may receive 256 elements every clock for 16 clocks cycles. The RMS normalizer unit 114 may include tree adder 1502 to add a number of values (e.g., 256 values) together simultaneously. The RMS normalizer unit 114 may include ROM 1504 storing a look-up table comprising one or more precomputed values of the function:

$$f ( x ) = {\sqrt{\frac{x}{4 , 096} + 1 {0}^{- 5}}}^{- 1} .$$

The rotary embedder unit 115 may apply rotary positional embeddings on input data. The rotary embedder unit 115 is the hardware implementation of one or more rotary position encoders in the DNN. The rotary embedder unit 115 may produce rotary positional encoded embeddings. In some embodiments, the rotary embedder unit 115 may provide the functionality of a sine cosine unit without the need to calculate/compute sine and cosine in real-time. The rotary embedder unit 115 may have a sine cosine unit that has a look-up table implementation. In some embodiments, the rotary embedder unit 115 may include a look-up table comprising one or more precomputed values of a cosine function

$$( e . g . , f ( t ) = cos ( {10}^{- \frac{{h}_{n}}{16}} \cdot t ) ) .$$

The rotary embedder unit 115 may include another look-up table comprising one or more precomputed values of sine function

$$( e . g . , f ( t ) = sin ( {10}^{- \frac{{h}_{n}}{16}} \cdot t ) ) .$$

The SiLU unit 116 is a hardware implementation of one or more SiLU activators in the DNN. The SiLU unit 116 may compute a SiLU activation function (“SiLU function”):

$$f ( x ) = \frac{x}{1 + {e}^{- x}}$$

The SiLU function may be decomposed into a linear function and a symmetric function to optimize efficiency of the SiLU unit 116. For instance, the SiLU function may be converted to a combination of a ReLU function and a SiLU−ReLU function. The ReLU function may be the linear component of the SiLU function, and the SiLU−ReLU function may be the nonlinear, symmetric component of the SiLU function. In some embodiments, the SiLU−ReLU function is an even function.

As shown in FIG. 1, the SiLU unit 116 includes a ReLU unit 141, a linear unit 142, an add unit 143, and a ROM 144. In other embodiments, the SiLU unit 116 may include fewer, more, or different components. Further, functionality attributed to a component of the SiLU unit 116 may be accomplished by a different component included in the SiLU unit 116 or by a different unit. For instance, the SiLU unit 116 may include a single unit or circuitry that performs the functionality attributed to two or more of the ReLU unit 141, linear unit 142, add unit 143, or ROM 144.

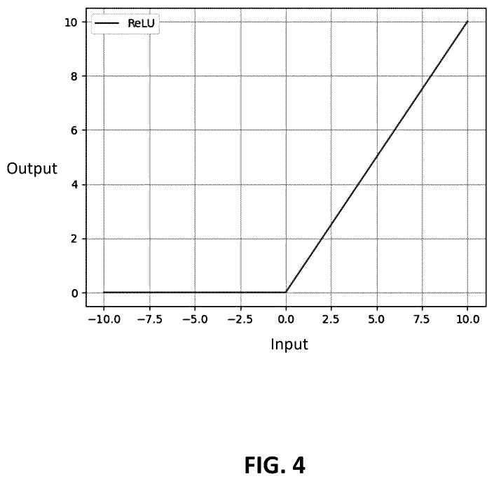

The ReLU unit 141 may implement the linear component of the SiLU function, i.e., the ReLU function. The ReLU unit 141 may output 0 when the input value received by the SiLU unit 116 is negative. The ReLU unit 141 may output the input value itself when the input value is positive or 0. Certain aspects regarding ReLU are described below in conjunction with FIG. 4.

The linear unit 142 may implement linear approximation of the nonlinear component of the SiLU function, i.e., the SiLU−ReLU function. The linear unit 142 may compute one or more linear functions to approximate the SiLU−ReLU function. The input range of the SiLU−ReLU function, which may be the same as the input range of the SiLU function, may be partitioned into a plurality of input ranges, which are also referred to as segments or input segments. Each input segment may correspond to a linear function that approximates the SiLU−ReLU function within the input segment. A linear function may be denoted as y=a×x+b, where a is slope or coefficient and b is intercept or bias. a and b are collectively referred to as linear parameters. The linear functions for different input segments may have different linear parameters.

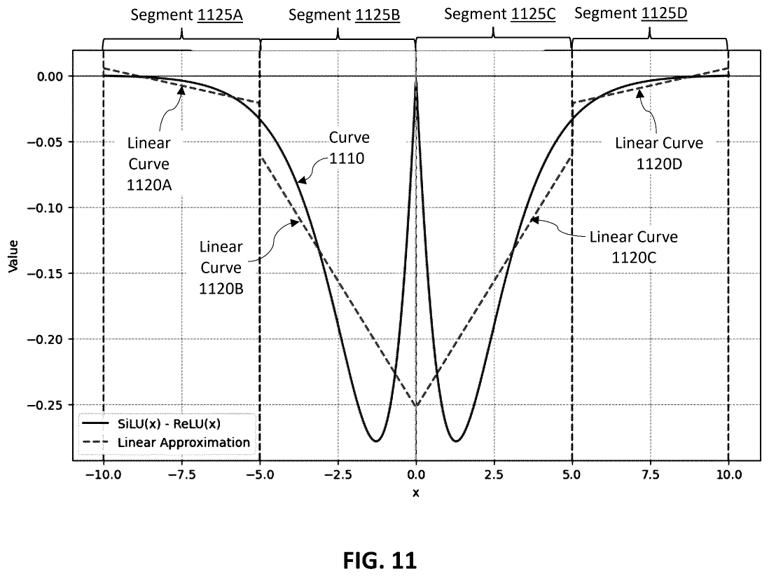

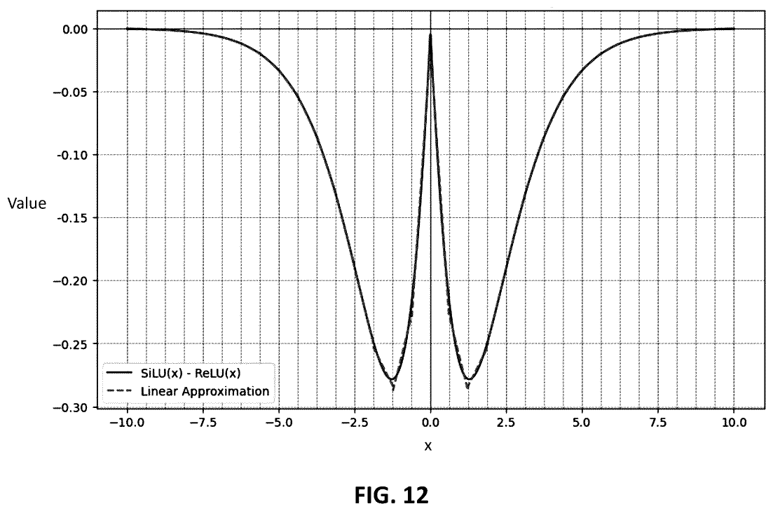

After the linear unit 142 receives an input value, the linear unit 142 may determine which segment the input value falls into. The linear unit 142 may select the segment of the input value from a plurality of segments based on the input value. In some embodiments (e.g., embodiments where the input value is a floating-point value), the linear unit 142 may select the segment based on the exponent or mantissa of the input value. As the SiLU−ReLU function is symmetric, the linear unit 142 may perform the same type of calculation for both positive input values and negative input values, which can save computational resources and make it more efficient to implement the SiLU−ReLU function onto hardware. In some embodiments, the linear unit 142 may apply a linear function on an absolute value of a negative input value to compute an intermediate value. The linear unit 142 may then apply a negative sign on the intermediate value to compute an output value. Certain aspects regarding linear approximation of SiLU−ReLU functions are described below in conjunction with FIGS. 11 and 12.

The add unit 143 may add outputs of the ReLU unit 141 and linear unit 142 to obtain the approximated outputs of the SiLU function. For instance, for each input value of the SiLU activator, the add unit 143 may add the output of the ReLU unit 141 and the output of the linear unit 142 to compute the output value of the SiLU activator. The output value may be an approximated output value, as opposed to the actual output value of the SiLU activator, for example, in embodiments where the linear unit 142 computes linear functions to approximate the SiLU−ReLU function. In some embodiments, the add unit 143 may correct errors associated with linear approximation performed by the linear unit 142. For instance, the add unit 143 may retrieve an error correction value from the ROM 144 and add the error correction value with the sum of the output of the ReLU unit 141 and the output of the linear unit 142 (“intermediate sum”) to compute a approximated output value that is a more accurate approximation of the actual output value of the SiLU activator than the intermediate sum.

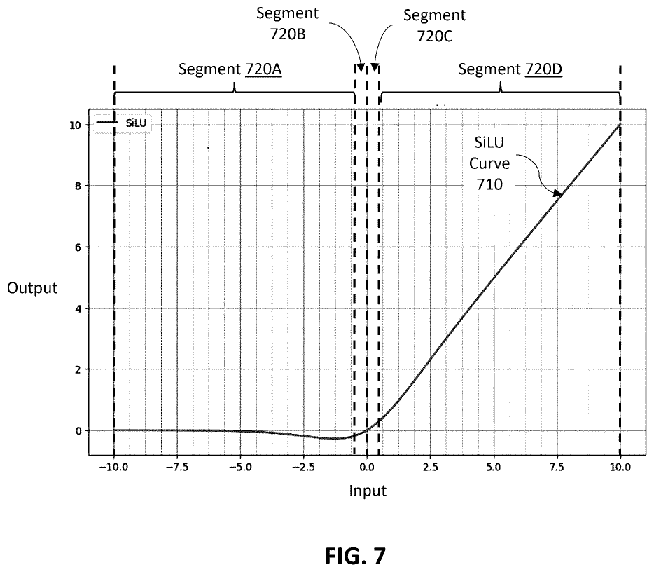

In some embodiments, the ReLU unit 141 and certain functionality of the add unit 143 may be bypassed. For instance, linear functions may be used to approximate the SiLU activation function directly, as opposed to approximating the SiLU−ReLU function. Different ones of the linear functions may correspond to different segments of the input range of the SiLU activation function. The linear unit 142 may apply the right linear function on each input value to compute an approximated output of the SiLU activator. In some embodiments, the add unit 143 may correct errors in the approximated outputs. Segmentation, range selection, or error correction for directly approximating the SiLU activation function may be the same or similar as the techniques used for approximating the SiLU−ReLU function. Certain aspects regarding linear approximation of SiLU activation functions are described below in conjunction with FIGS. 7-10.

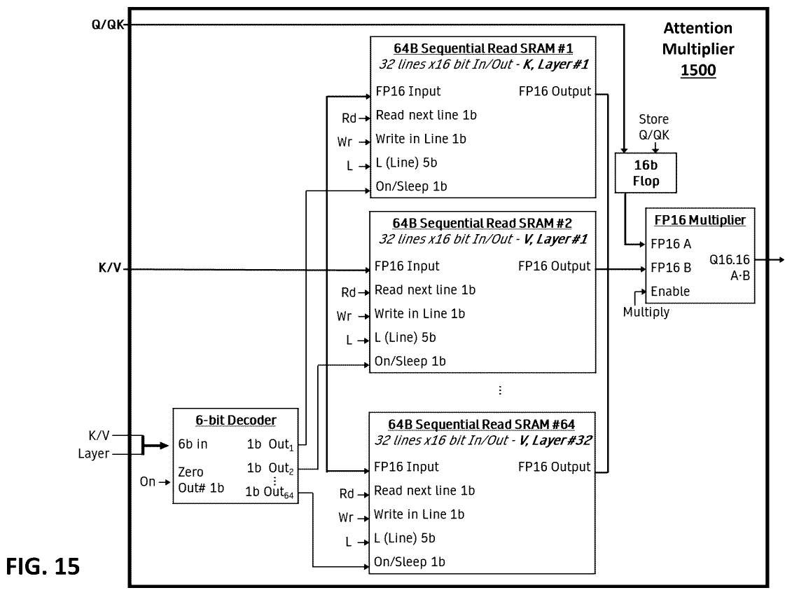

The ROM 144 stores data used by the ReLU unit 141, linear unit 142, and add unit 143 for performing computations described above. For example, the ROM 144 may store linear parameters of the linear functions approximating the SiLU−ReLU function. As another example, the ROM 144 may store error correction values. The ROM 144 may be a sequential ROM. The ROM 144 may be located proximate to the ReLU unit 141, linear unit 142, and add unit 143 for efficient retrieve of data from the ROM 144. Certain aspects regarding sequential ROM are described below in conjunction with FIG. 15.

The SoftMax unit 117 is a hardware implementation of one or more SoftMax activators in the DNN. The SoftMax unit 117 may implement a SoftMax function for output probability distribution. In some embodiments, the SoftMax unit 117 may execute a SoftMax function using one or more look-up tables that are pre-configured with precomputed data. The SoftMax function may be:

$$\frac{{e}^{\frac{{x}_{i} - {x}_{m ax}}{\sqrt{128}}}}{{\sum }_{j = 0}^{t} {e}^{\frac{{x}_{j} - {x}_{m ax}}{\sqrt{128}}}}$$

In some embodiments, the SoftMax unit 117 includes look-up table implementation of the SoftMax function instead of a compute-oriented solution. In some embodiments, the SoftMax unit 117 receives an input vector of t FP16 elements (1<t<512) and returns the SoftMax normalized vector of the same size. The SoftMax unit 117 receives 16 numbers per cycle for up to 32 cycles and returns 16 numbers per cycle for up to 32 cycles.

In an example, the SoftMax unit 117 receives an input vector including 16 elements, each of which is a FP16 value, in a clock cycle. The total number of bits of the input vector is 256. The SoftMax unit 117 may also receive a compare control signal, normalize control signal, exponent control signal, multiply control signal, on/off control signal, other types of control signals, or some combination thereof. A control signal may have 1 bit. The output of the SoftMax unit 117 may be 16 elements with FP16 format. The total number bits may be 240. The SoftMax unit 117 may execute the SoftMax function using 16 clock cycles. Numbers may be stored in a first-in-first-out (FIFO) buffer while they are compared to find the largest number in the vector. The FIFO buffer may output numbers. The largest number may be subtracted. The subtraction result is provided to a look-up table. The output of the look-up table enters a second FIFO. Numbers may be pulled out of the second FIFO and multiplied by the normalization value. It may take a total of 24 cycles to compute the output. The 24 cycles may include 8 latency cycles and 16 piping cycles

In some embodiments, the SoftMax unit 117 may be included in the attention dot unit 131 to perform SoftMax on an input vector (e.g., FP16 vector) and to output a SoftMax-ed vector (e.g., FP16 vector). The SoftMax unit 117 may include a look-up table comprising one or more precomputed values of an exponent function:

$$f ( x ) = {e}^{\frac{x}{\sqrt{128}}} .$$

The SoftMax unit 117 may include another look-up table comprising one or more precomputed values of a reciprocal function:

$$f ( x ) = \frac{1}{x} .$$

The SoftMax unit 117 may include a tree adder that can add a number of values (e.g., 18 values) together simultaneously.

The sampler unit 118 is a hardware implementation of one or more samplers in the DNN. The sampler unit 118 may sample from the output distribution. In some embodiments, the sampler unit 118 may receive an input vector and compare elements of the input vector to find the largest value. The sampler unit 118 may determine the index of the largest number and return a token. In some embodiments, the sampler unit 118 may receive a logits vector. In an example, the vector may include 32,000 elements. In some embodiments, the sampler unit 118 may receive 256 input elements for a cycle and may take 125 cycles to process the 32,000. The input elements may be in FP16 format. The total number of bits for the 256 input elements may be 4,096 bits. In some embodiments, the 256 input elements may be received from 256 MatMul units, such as 256 attention dot units, respectively. In some embodiments, the sampler unit 118 may implement a deterministic sampler having zero temperature. The sampler unit 118 may also receive control signals, such as an on/off signal indicating whether the sampler unit 118 is to be on or off, a restart signal indicating whether to restart the sampler unit 118, and a run signal. A control signal may have 1 bit. The sampler unit 118 may determine an index, such as a 32-bit index, corresponding to the largest number in the input vector. The index may correspond to an output token. In some embodiments, the output token may be a 15-bit integer.

In some embodiments, the sampler unit 118 includes 256 sampling comparators. In other embodiments, the sampler unit 118 may include a different number of sampling comparators. With the 256 sampling comparators, the sampler unit 118 can compare 256 input elements every clock cycle and keeps the index and value of the largest number. Each sampling comparator may compare two logits or values in a single clock cycle and return the larger number of its index (token). Each value may have 16 bits and may be in the FP16 format. The index (token) may be a 15-bit integer. The output may include the larger value as well as the index of the larger value. In a situation where more than one number has the largest value, the sampler unit 118 may return the token with the lowest index out of the equal tokens. When finishing the 125 clock cycles, the sampler unit 118 returns the token of the largest value in the input vector. For instance, the sampler unit 118 may output the index of the largest value in the input vector.

In some embodiments, the sampler unit 118 may have sampling comparators arranged in a tree or hierarchical structure to efficiently compare a large number of values (e.g., hundreds or thousands of values or more) simultaneously. For instance, each comparator in the first tier may compare two values in the input vector and select the larger value, each comparator in the second tier may compare two values from two comparators, respectively, in the first tier, each comparator in the third tier may compare two values from two comparators, respectively, in the second tier, and so on. The last tier may include a comparator that outputs the largest value of the input vector. In some embodiments, the sampler unit 118 may have a latency of 9 clock cycles. Every layer of comparators may be pipeline. In some embodiments, the sampler unit 118 may have power gating.

The embedding dot unit 120 is hardware implementation of embedding computations in the DNN. For instance, the embedding dot unit 120 may implement MatMul operators and add operators in the DNN, such as the MatMul operators and add operators in one or more encoders of the DNN. The embedding dot unit 120 may handle the initial embedding of tokens, performing matrix multiplications to transform input data into a suitable format for the DNN. The embedding dot unit 120 may convert input tokens into dense vector representations, which may be essential for subsequent processing in the DNN. In some embodiments, the embedding dot unit 120 are compute-in-memory units, which hold the static weights of the DNN. The static weights may be weights that do not change during inference of the DNN. The embedding dot unit 121 includes a plurality of ROM-multiply-add units 122 (individually referred to as “ROM-multiply-add unit 122”) and an add unit 123. ROM-multiply-add units may also be referred to as ROM-Mul-add units or ROMUL-add units hereinbelow. This ROM-based design can ensure efficient storage and quick access to static weights, enhancing the speed and efficiency of embedding operations.

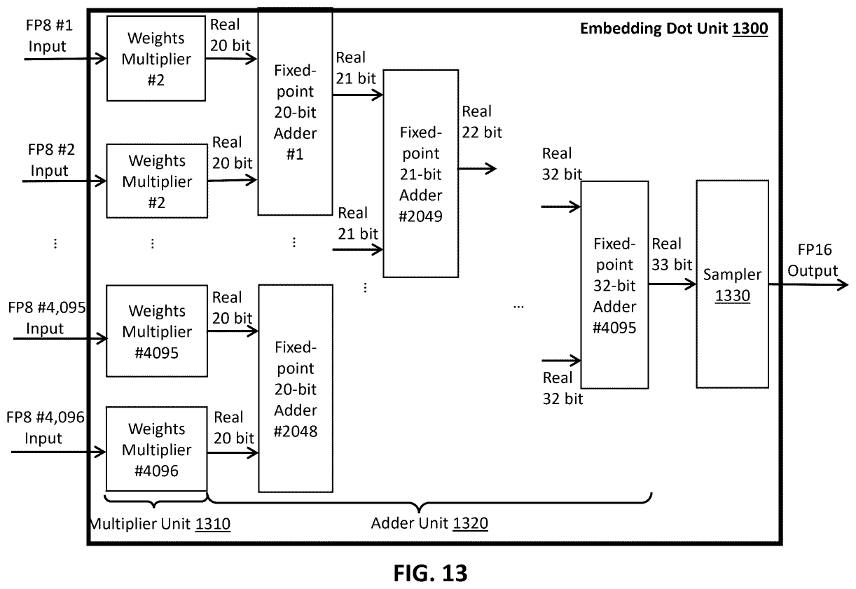

In some embodiments, the ROM-multiply-add units 122 may perform MatMul operations. A MatMul operation may be performed on a weight tensor and an activation tensor. The activation tensor may be the output of the previous operators in the DNN. Weight tensors used by the ROM-multiply-add units 122 may be stored in the ROMs of the ROM-multiply-add units 122. The ROMs may be sequential ROMs. Sequence ROM is a type of memory storage, utilizing ROMs, that allows data to be read sequentially but not written or modified after the values have been etched onto the ROM. The rest of the ROM can be shut down to reduce power and area. The add unit 123 may accumulate outputs of the ROM-multiply-add units 122. Certain aspects regarding embedding dot units are described below in conjunction with FIG. 13.

The attention dot unit 130 is hardware implementation of attention computations in the DNN. For instance, the attention dot unit 130 may implement MatMul operators and add operators in the DNN, such as the MatMul operators and add operators in one or more decoders of the DNN. The attention mechanism may be critical for understanding the relationships between different parts of the input sequence. The attention dot unit 130 may focus on the computation of attention scores and the weighted sum of value vectors, which may be critical for capturing dependencies and relationships between different parts of the input data. The attention dot unit 130 may be compute-in-memory dies. The attention dot unit 130 may utilize sequential RAM to handle the dynamic nature of attention computations. This sequential RAM-based design can allow for fast and efficient computation of attention scores, leveraging high memory bandwidth and low latency to optimize performance.

As shown in FIG. 1, the attention dot unit 131 includes a plurality of RAM-multiply-add units 132 (individually referred to as “RAM-multiply-add unit 132”) and an add unit 133. In some embodiments, each RAM-multiply-add unit 132 may include one or more multipliers, RAMs, and tree adders. In one implementation, a RAM-multiply-add unit 132 may carry out a (128-elements) dot product operation between FP16 input vector and FP16 K or V vector cached in one or more RAMs, e.g., every cycle. The dot product operation can be performed using the one or more multipliers and one or more tree adders in the RAM-multiply-add unit 132. A multiplier may multiple two values, such as two floating-point values. In an example, the attention dot unit 131 one or more FP16/FP16 multipliers. A multiplier may be specifically designed to perform multiplication of data having predetermined representations (e.g., FP4, FP6, FP8, FP12, FP16, INT8, etc.). One or more multipliers in the attention dot unit 131 may receive data from one or more RAMs. One or more tree adders may add multiplication results produced by one or more multipliers together.

The RAMs can store and provide data to one or more circuits performing logic operations in the RAM-multiply-add units 132. In some embodiments, a RAM-multiply-add unit 132 may receive an input number and multiplies it by a number from the RAM of the RAM-multiply-add unit 132 in every clock cycle. In some embodiments, a RAM may be a sequential read/write memory, such as a sequential read/write static random-access memory (SRAM). A sequential read/write memory can be used with or in an attention dot unit to supply weights to a multiplier in the RAM-multiply-add unit 132. A RAM that can be read sequentially or written sequentially may have drastically simplified logic and circuitry for reads or writes. The RAM may be used in a special configuration where it is not dynamically readable but is built up sequentially to reduce power and area.

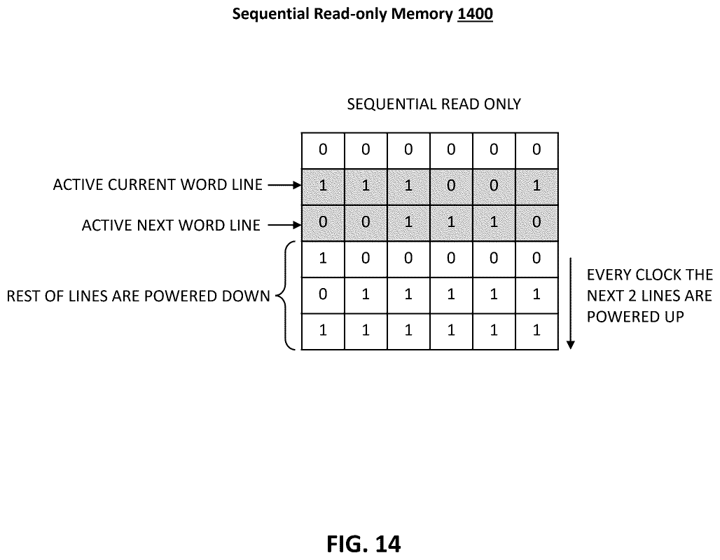

In some embodiments, a RAM of a RAM-multiply-add unit 132 may be placed in proximity to the circuits performing logic operations in the RAM-multiply-add unit 132. The RAM may store intermediate values of the DNN. The intermediate values may be dynamic during the DNN inference, meaning their values may change. For instance, the RAM may store a key-value (KV) cache. New keys or values may be written into the RAM as they are generated. The RAM may be referred to as KV RAM. In embodiments where the RAM is a SRAM, it may be referred to as a KV SRAM. KV RAM can enable storing the attention history (e.g., cached keys and values) of a transformer block. In an exemplary implementation, 64 SRAMs may be used to store the 32 layers and K vs. V separately, so the SRAM can read lines sequentially. The tree adders in the RAM-multiply-add units 132 may add multiplication results produced by the multipliers together. A tree adder may also be referred to as an adder tree and may include adders arranged in a tree structure. The add unit 133 may add outputs of the RAM-multiply-add units 132. Certain aspects of the attention dot unit 130 are described below in conjunction with FIG. 14.

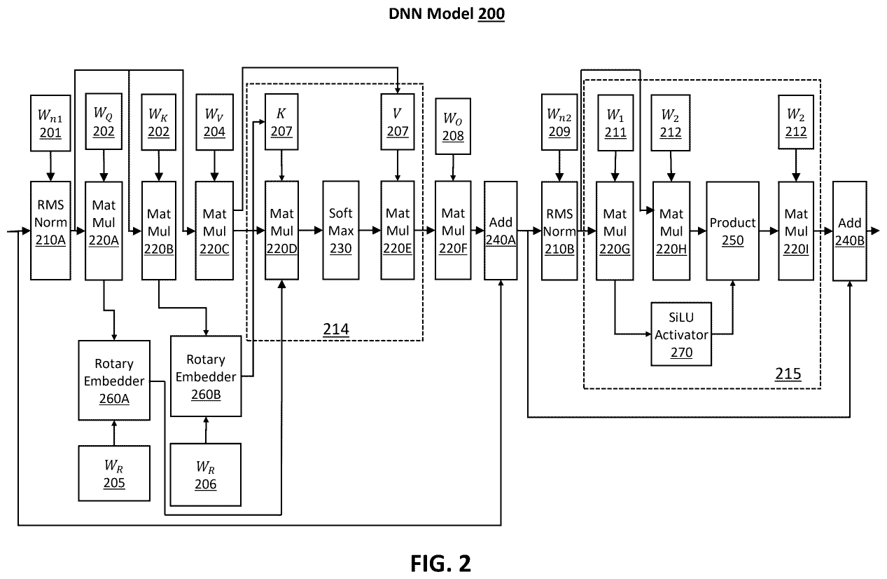

FIG. 2 illustrates an inference process of a DNN model 200, in accordance with various embodiments. In the embodiment of FIG. 2, the DNN model 200 is a transformer-based model. For instance, the DNN model 200 may be LLM, speech recognition model, and so on. The DNN model 200 may process input embeddings through a series of highly optimized neural network operations to generate output. The DNN model 200 may be embedded on an IC device, such as the IC device 100 in FIG. 1. For instance, the weights of the DNN model 200 may be stored in memories of the IC device 100, and operators in the DNN model 200 may be mapped to compute units of the IC device 100.

As shown in FIG. 2, the DNN model 200 includes RMS normalizers 210A and 210B, MatMul operators 220A-3201, SoftMax activator 230, add operators 240A and 240B, product operator 250, rotary embedders 260A and 260B, and SiLU activator 270. These operators are arranged in a sequence as shown in FIG. 2. The sequence may indicate a timing sequence of the operators during the inference process. For the purpose of illustration, RMS normalizer is shown as “RMS norm” in FIG. 2, MatMul operator is shown as “MatMul” in FIG. 2, SoftMax activator is shown as “SoftMax” in FIG. 2, add operator is shown as “add” in FIG. 2, and product operator is shown as “product” in FIG. 2. In other embodiments, the DNN model 200 may include fewer, more, or different components. Also, the arrangement of the components in the DNN model 200 may be different.

The RMS normalizer 210A can standardize input data, such as input embeddings. The RMS normalizer 210A may perform an RMS normalization on an input to the DNN model 200 using a weight vector 201. In an example, the spatial size of the weight vector 201 may be 4, meaning the weight vector 201 includes 4 data elements in it. The RMS normalization may be denoted as

$$y = \frac{{x}_{i} \cdot {W}_{RM {S}_{i}}}{\sqrt{\frac{{\sum }_{j = 0}^{4 , 096} {x}_{j}^{2}}{4 , 096} + {10}^{- 5}}} ,$$

where i and j are indices, x is the input, W_{RMS} is the weight (which may be referred to as RMS attention weights), and y is the output. The weight vector 201 may also denoted as Wₙ₁. The RMS normalization can normalize input data elements of the DNN model 200 based on the RMS of the activations. The normalization may stabilize the inputs and ensure that the attention weights can be computed on approximately scaled inputs, leading to better training stability and faster convergence. The output of the RMS normalizer 210A may be one or more tokens. In an example, the token may be represented by a 15-bit integer. The output of the RMS normalizer 210A is a vector. In an example, the dimension of the vector is 4.

At least some of the MatMul operators 220A-320F can handle the transformation and integration of embedding vectors across different layers. As shown in FIG. 2, the output of the RMS normalizer 210A is provided to the MatMul operator 220A. The MatMul operator 220A performs MatMul on the output of the RMS normalizer 210A and a weight matrix 202. The weight matrix 202 may be a matrix of query weights, which may be denoted as W_{Q}. The MatMul result is provided to the MatMul operator 220B. The output of the RMS normalizer 210A is also provided to the MatMul operator 220B. The MatMul operator 220B performs MatMul on the output of the RMS normalizer 210A and a weight matrix 203. The weight matrix 203 may be a matrix of key weights, which may be denoted as W_{K}. The output of the RMS normalizer 210A is also provided to the MatMul operator 220C. The MatMul operator 220C performs MatMul on the output of the RMS normalizer 210A and a weight matrix 204. The weight matrix 204 may be a matrix of value weights, which may be denoted as W_{V}. The MatMul result of the MatMul operator 220A, MatMul operator 220B, or MatMul operator 220C may be a vector. In an example, the spatial size of the weight matrix 202, weight matrix 203, or weight matrix 204 is 4×4; and the dimension of the vector computed by the MatMul operator 220A, MatMul operator 220B, or MatMul operator 220C is 4.

The MatMul result computed by the MatMul operator 220A is provided to the rotary embedder 260A. The rotary embedder 260A may apply a weight matrix 205 on input data. The weight matrix 205 is represented by W_{R} in FIG. 2. The rotary embedder 260A may produce rotary positional encoded embeddings. In some embodiments, the operation of the rotary embedder 260A may be:

$$f ( {x}_{i} ) = {x}_{i} \cdot {w}_{r} - {x}_{i + 1} \cdot {w}_{i} , and$$

$$f ( {x}_{i + 1} ) = {x}_{i} \cdot {w}_{i} + {x}_{i + 1} \cdot {w}_{r} .$$

where x is the input to the MatMul operator 220A, and w is weight. In an example, the dimension of the weight matrix 205 is 128×512.

The MatMul result computed by the MatMul operator 220B is provided to the rotary embedder 260B. The rotary embedder 260B may apply a weight matrix 206 on input data. The weight matrix 206 is represented by W_{R} in FIG. 2. The rotary embedder 260B may produce rotary positional encoded embeddings. In some embodiments, the operation of the rotary embedder 260B may be:

$$f ( {x}_{i} ) = {x}_{i} \cdot {w}_{r} - {x}_{i + 1} \cdot {w}_{i} , and$$

$$f ( {x}_{i + 1} ) = {x}_{i} \cdot {w}_{i} + {x}_{i + 1} \cdot {w}_{r} .$$

where x is the input to the MatMul operator 220B, and w is weight. In an example, the dimension of the weight matrix 206 is 128×512.

The output of the rotary embedder 260A or rotary embedder 260B may be a vector. In an example, the dimension of the vector is 4. The output of the rotary embedder 260A is provided to the MatMul operator 220D. The MatMul operator 220D also receives keys from a KV cache 207. The cache 207 receives keys from the rotary embedder 260B. the MatMul operator 220D may perform a MatMul operation on the keys and the output of the rotary embedder 260A to compute a vector. In an example, the keys may be in a matrix, e.g., a matrix with a dimension of 2×<1024, in which <1024 may be a timestamp dimension T; the data received from the rotary embedder 260A may be a vector with a dimension of 2; and the output of the MatMul operator 220D may be a vector with a dimension of <1024.

The output of the MatMul operator 220D is provided to the SoftMax activator 230. The SoftMax activator 230 may apply a SoftMax function on the output of the MatMul operator 220D. The SoftMax function may be denoted as

$$\frac{{e}^{\frac{{x}_{i} - {x}_{m ax}}{\sqrt{64}}}}{{\sum }_{j = 0}^{t} {e}^{\frac{{x}_{j} - {x}_{m ax}}{\sqrt{64}}}} .$$

In an example, the output of the SoftMax activator 230 may be a vector with a dimension of <1024.

The output of the SoftMax activator 230 is provided to the MatMul operator 220E. The MatMul operator 220E also receives values from the cache 207. In some embodiments, at least some of the values are computed by the rotary embedder 260B. In an example, the values may be in a matrix, e.g., a matrix with a dimension of <1024×2, in which <1024 may be a timestamp dimension T; and the output of the MatMul operator 220E may be a vector with a dimension of 2. In some embodiments, T=1 for the first token. The context size may be denoted as Max T. In some embodiments, the MatMul operator 220D, SoftMax activator 230, and MatMul operator 220E may constitute a multi-headed attention block 214. In some embodiments, the DNN model 200 may include a plurality of multi-headed attention blocks 214 that can run in parallel. For instance, two embedding vectors may be split to two heads sized 2. The multi-headed attention block 214 may be a multi-headed attention layer.

The output of the MatMul operator 220E is input into the MatMul operator 220F. The MatMul operator 220F also receives a weight matrix 208. The weight matrix 208 is shown as W₀ in FIG. 2. In an example, the dimensions of the weight matrix 208 is 4×4. The data received by the MatMul operator 220F from the MatMul operator 220E may be a vector, whose dimension may be 4. The output of the MatMul operator 220F may be a vector, whose dimension may be 4.

The output of the MatMul operator 220F is provided to the add operator 240A. The operators 240A may perform an elementwise addition on the output of the MatMul operator 220F and the input to the RMS normalizer 210. In some embodiments, the elementwise addition is denoted as ƒ(x,y)=x+y. In an example, the two inputs to the operators 240A may each be a vector with a dimension of 4, and the output of the operators 240B may also be a vector with a dimension of 4.

The output of the operators 240A is provided to the RMS normalizer 210B. The RMS normalizer 210B can standardize data it receives. The RMS normalizer 210B may perform an RMS normalization on the output of the operators 240A using a weight vector 209. In an example, the spatial size of the weight vector 201 may be 4. The RMS normalization may be denoted as

$$y = \frac{{x}_{i} \cdot {W}_{RM {S}_{i}}}{\sqrt{\frac{{\sum }_{j = 0}^{4 , 096} {x}_{j}^{2}}{4 , 096} + {10}^{- 5}}} ,$$

where i and j are indices, x is the input, W_{RMS} is the weight (which may be referred to as RMS attention weights), and y is the output. The weight vector 209 may also denoted as Wₙ₂. The RMS normalization can normalize data elements based on the RMS of the data elements. The normalization may stabilize the inputs and ensure that the attention weights can be computed on approximately scaled inputs, leading to better training stability and faster convergence. The output of the RMS normalizer 210B may be one or more tokens. In an example, the token may be represented by a 15-bit integer. In some embodiments, the output of the RMS normalizer 210B is a vector. In an example, the dimension of the vector is 4.

The output of the RMS normalizer 210B is provided to the MatMul operator 220G. The MatMul operator 220G also receives a weight matrix 211. The weight matrix 211 is shown as W₁ in FIG. 2. In an embodiment, the spatial shape of the weight matrix 211 is 4×10, the dimension of the output of the RMS normalizer 210B is 4, and the dimension of the output of the 220G is 10. The output of the MatMul operator 220G is provided to the SiLU activator 270. The SiLU activator 270 may apply a SiLU function on the output of the MatMul operator 220G. The SiLU activator 270 may perform the SiLU operation in an elementwise manner, meaning for every data element input into the SiLU activator 270, the SiLU activator 270 applies the SiLU function and computes an output data element. In an example, the input to the SiLU activator 270 is a vector including 10 data elements, and the output of the SiLU activator 270 is also a vector including 10 data elements.

The output of the RMS normalizer 210B is also provided to the MatMul operator 220H. The MatMul operator 220H also receives a weight matrix 212. The weight matrix 212 is shown as W₃ in FIG. 2. In an embodiment, the spatial shape of the weight matrix 212 is 4×10, the dimension of the output of the RMS normalizer 210B is 4, and the dimension of the output of the 220H is 10.

The output of the MatMul operator 220H is provided to the product operator 250. The product operator 250 also receives the output of the SiLU activator 270. The product operator 250 may perform an elementwise multiplication on the two inputs. The elementwise multiplication may be denoted as ƒ(x,y)=x·y. In some embodiments, the two inputs are each a vector including 10 data elements, and the output of the product operator 250 is also a vector including 10 data elements.

The output of the product operator 250 is provided to the MatMul operator 220I. The MatMul operator 220I also receives a weight matrix 213. The weight matrix 213 is shown as W₂ in FIG. 2. In an embodiment, the spatial shape of the weight matrix 213 is 10×4, the dimension of the output of the product operator 250 is 10, and the dimension of the output of the 220I is 4. In some embodiments, the MatMul operator 220G, 220H, product operator 250, and MatMul operator 220I may constitute a feed forward neural network 215. The 215 may be denoted as W₂(Silu(W₁(x))×W₃(x)). The feed forward neural network 215 can ensure rapid and effective data processing.

The output of the MatMul operator 220I is provided to the add operator 240B. the operators 240B also receives the output of the operators 240A. The operators 240B may perform an elementwise addition on the two inputs. The elementwise addition may be denoted as ƒ(x,y)=x+y. In an example, the two inputs are each a vector including 4 data elements, and the output of the operators 240B is also a vector including 4 data elements. The output of the operators 240B may be an output of the DNN model 200.

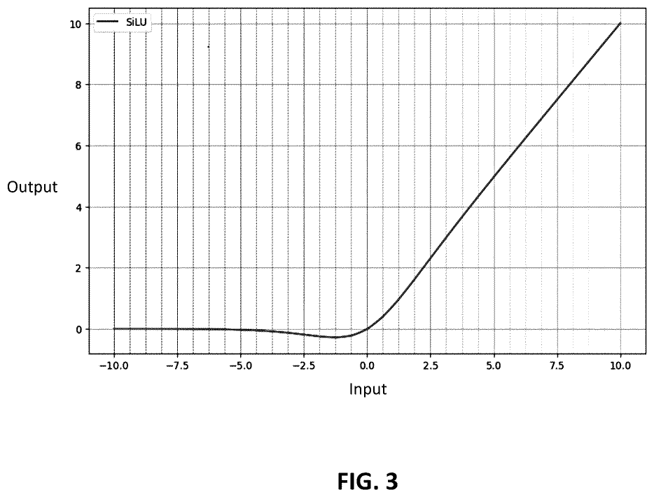

FIG. 3 illustrates a SiLU activation function, in accordance with various embodiments. An example of the SiLU activation function is the SiLU activator 270 of the DNN model 200 in FIG. 2. The SiLU activation function may be used in other DNNs. As shown in FIG. 3, the SiLU activation function is a nonlinear function. In some embodiments, the SiLU activation function is defined as

$$SiLU ( x ) = \frac{x}{1 + {e}^{- x}} ,$$

where x denotes the input, and SiLU(x) denotes the output. The SiLU activation function may be a function of multiplying the input by its sigmoid activation and may be denoted as SiLU(x)=x·σ(x), where

$$σ ( x ) = \frac{1}{1 + {e}^{- x}} .$$

As shown in FIG. 3, the curve of the SiLU activation function is smooth and non-monotonic, which can help with optimization and gradient flow. The output can be “gated” by the sigmoid, allowing small negative values to pass through. For large negative input values, the output of the SiLU activation function can approach zero. For large positive input values, the output of the SiLU activation function can approach the input value. When the input value is around zero, the SiLU activation function is close to linear but slightly curved due to the sigmoid.

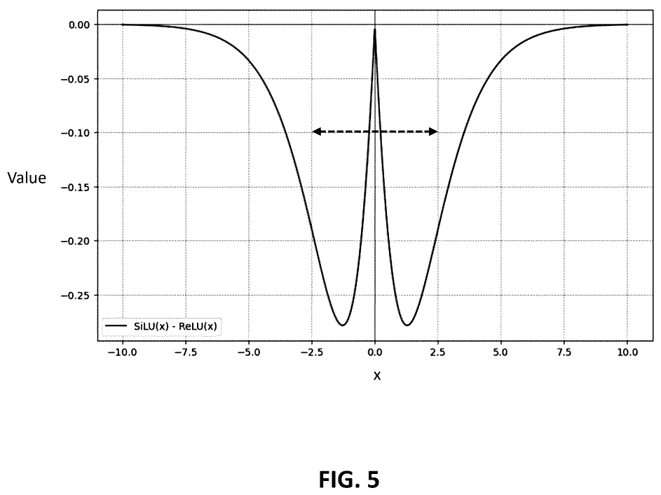

Executing activation functions can consume significant computational resources. The SiLU activation function involves complex mathematical operations that can demand considerable processing power. This need for computation can contribute to the overall latency and power consumption of the model. Also, the SiLU function can be complex to implement directly in hardware due to its nonlinear nature. In various embodiments of this disclosure, the SiLU activation function may be decomposed into a linear function and a nonlinear, symmetric function to improve the efficiency of executing the SiLU activation function. In an example, the decomposition may be denoted as SiLU(x)=ReLU(x)+(SiLU(x)−ReLU(x)), in which ReLU(x) is the linear component (e.g., a piecewise linear function) of SiLU(x) and SiLU(x)−ReLU(x) is the nonlinear, symmetrical component of SiLU(x). Certain aspects regarding the linear function are described below in conjunction with FIG. 4. Certain aspects regarding the nonlinear, symmetric function are described below in conjunction with FIG. 5.

FIG. 4 illustrates a ReLU function, in accordance with various embodiments. The ReLU function may be defined as ƒ(x)=max (0,x). When the input value x is positive, the output is x; when x is negative or 0, the output is 0. In some embodiments, the ReLU function may be the linear component of a SiLU activation function in a DNN, such as the SiLU activator 270 in FIG. 2.

The ReLU function may be approximated as a straight line, as shown in FIG. 4. The ReLU function may be implemented in hardware, e.g., the SiLU unit 116 in FIG. 1. The use of the ReLU function can reduce hardware computation. Table 1 below shows how use of linear functions can reduce hardware computation in various embodiments.

TABLE 1
Nonlinear vs. linear hardware implementations

| Criteria | Linear Computation on Segments | Nonlinear Computation in Hardware |
|---|---|---|
| Complexity | Involves less complex operations | Involves more complex mathematical |
| | (e.g., addition, subtraction, | functions (e.g., exponentiation, |
| | multiplication, division) | logarithms, trigonometric functions) |
| Resource | Requires fewer logic gates and | Requires specialized hardware, more |
| Utilization | simpler arithmetic units | logic gates, and complex arithmetic |
| | | units |
| Ease of | Relatively straightforward and | Can be challenging and may require |
| Implementation | well-understood | approximation techniques or look-up |
| | | tables |
| Performance | Linear operations can be | Additional complexity can slow down |
| | executed quickly | computation |
| Scalability | Easier to scale by adding more | Scaling leads to exponential growth in |
| | segments | complexity and resource requirements |
| Debugging and | Easier to identify and fix issues | More subtle and complex bugs, making |
| Testing | due to simplicity | debugging and testing challenging |
| Power | Typically consumes less power | Often consumes more power due to |
| Consumption | | increased complexity |
| Precision and | Easier to achieve high precision | Maintaining precision and accuracy can |
| Accuracy | with fixed-point or floating-point | be difficult, may require interpolation |
| | arithmetic | or high-precision arithmetic |

FIG. 5 illustrates a symmetric function, in accordance with various embodiments. The nonlinear, symmetric function may be the nonlinear component of a SiLU activation function, such as the SiLU activator 270 in FIG. 2. In some embodiments, the symmetric function may be defined as SiLU(x)−ReLU(x). The symmetric function may be an even function, meaning ƒ(x)=ƒ(−x). Symmetry of the function can simplify calculations by computing values for positive inputs and mirroring these for negative inputs. In the embodiments of FIG. 5, the SiLU activation function exhibits symmetry between positive and negative inputs in the computation of SiLU(x)−ReLU(x). This symmetry can reduce the number of computations required and simplify the hardware design. In some embodiments, the hardware device computes the nonlinear function for positive inputs and mirrors the results for negative inputs.

Table 2 below shows the symmetry of the nonlinear function in some embodiments.

TABLE 2
SiLU(x)−ReLU(x) symmetry

| | | | | Same as |
|---|---|---|---|---|
| # | Input | SiLU−ReLU(x) | SiLU−ReLU(−x) | line # |
| 0 | −10 | −0.000454 | −0.000454 | 20 |
| 1 | −9 | −0.001111 | −0.001111 | 19 |
| 2 | −8 | −0.002683 | −0.002683 | 18 |
| 3 | −7 | −0.006377 | −0.006377 | 17 |
| 4 | −6 | −0.014836 | −0.014836 | 16 |
| 5 | −5 | −0.033464 | −0.033464 | 15 |
| 6 | −4 | −0.071945 | −0.071945 | 14 |
| 7 | −3 | −0.142278 | −0.142278 | 13 |
| 8 | −2 | −0.238406 | −0.238406 | 12 |
| 9 | −1 | −0.268941 | −0.268941 | 11 |
| 10 | 0 | 0 | 0 | 10 |
| 11 | 1 | −0.268941 | −0.268941 | 9 |
| 12 | 2 | −0.238406 | −0.238406 | 8 |
| 13 | 3 | −0.142278 | −0.142278 | 7 |
| 14 | 4 | −0.071945 | −0.071945 | 6 |
| 15 | 5 | −0.033464 | −0.033464 | 5 |
| 16 | 6 | −0.014836 | −0.014836 | 4 |
| 17 | 7 | −0.006377 | −0.006377 | 3 |
| 18 | 8 | −0.002683 | −0.002683 | 2 |
| 19 | 9 | −0.001111 | −0.001111 | 1 |
| 20 | 10 | −0.000454 | −0.000454 | 0 |

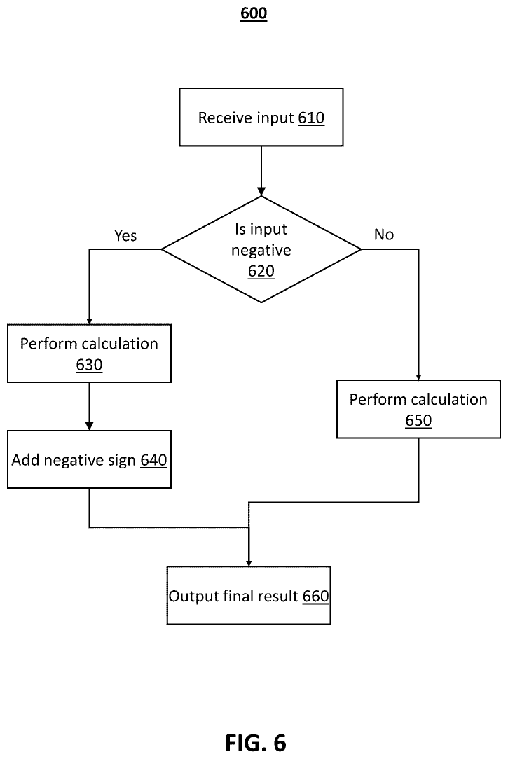

FIG. 6 illustrates a process 600 of a hardware device computing a symmetric function, in accordance with various embodiments. An example of the hardware device is the SiLU unit 116 in FIG. 1. In some embodiments, the process 1000 is performed by the linear unit 142 in the SiLU unit 116.

In the embodiments of FIG. 6, the process 600 starts with the SiLU unit 116 receiving an input in Step 610. Then the SiLU unit 116 determines whether the input is negative in Step 620. In embodiments where the SiLU unit 116 determines that the input is negative, the SiLU unit 116 performs calculation in Step 630. The calculation may be the computation of SiLU(|x|)−ReLU(|x|). The SiLU unit 116 then add negative sign in Step 640. After adding the negative sign, the SiLU unit 116 outputs the result in Step 660. In embodiments where the SiLU unit 116 determines that the input is not negative (e.g., the input is zero or positive), the SiLU unit 116 performs calculation in Step 650. The calculation may be the computation of SiLU(x)−ReLU(x). The SiLU unit 116 then outputs final result in Step 660.

The calculation in Step 630 and the calculation in Step 650 may be the same as both are performed on positive values. Therefore, the same hardware can be used for both positive and negative inputs by exploiting the symmetry in the SiLU(x)−ReLU(x) function, with the sign bit being forwarded to the final result for negative inputs. This method for handling symmetric functions in hardware can ensure efficient processing of both positive and negative inputs.

FIG. 7 illustrates segmenting a SiLU activation function, in accordance with various embodiments. An example of the SiLU activation function is the SiLU activator 270 in FIG. 2. The SiLU activation function is represented by a SiLU curve 710 in FIG. 7. In some embodiments, the input range of the SiLU activation function is partitioned into segments. The input range may be a range that includes all the input values of the SiLU activation function. Each segment is a portion of the input range and may also be referred to as an input region. For each segment, the SiLU activation function can be approximated by computing a linear function.

For the purpose of illustration, the input range in FIG. 7 is from −10.0 to 10.0. The input range of the SiLU activation function is divided into four segments 720A-720D (collectively referred to as “segments 720” or “segment 720”). The dashed vertical lines indicate the boundaries of the segments 720. The segment 720A may be from −10 to 0, the segment 720B may be from −0.7 to 0, the segment 720C may be from 0 to 0.7, and the segment 720D may be from 0.7 to 10. In other embodiments, the input range of the SiLU activation function may be partitioned into fewer, more, or different segments.

The linear function of each segment 720 may be denoted as ƒ(x)=a×x+b, where a denotes the slope of the linear curve and b denotes the intercept of the linear curve. The linear functions of different segments 720 may have different slopes or intercepts. By dividing the input range into four segments, the SiLU activation function can be executed by performing linear approximation within each segment of the input range. This piecewise linear approximation can reduce the computational complexity and make it feasible to implement in hardware.

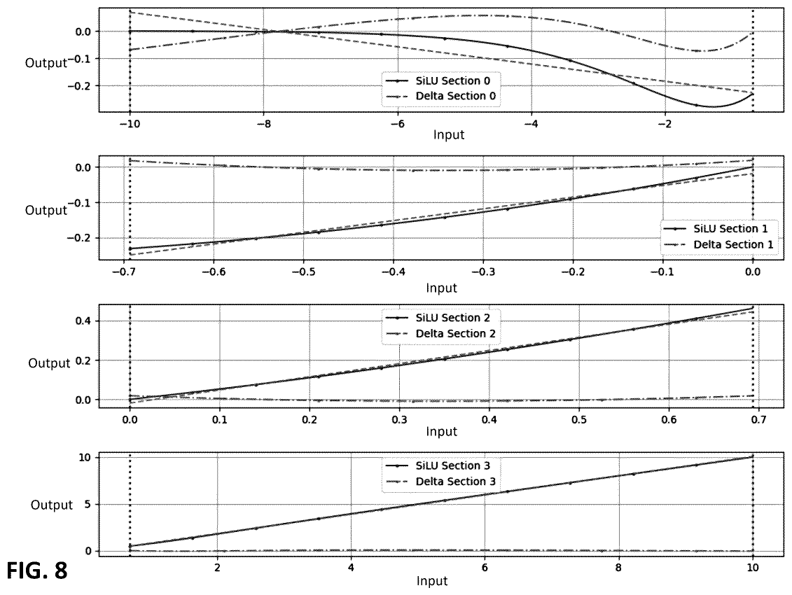

FIG. 8 illustrates linear approximation of a SiLU activation function, in accordance with various embodiments. As an example, FIG. 8 includes four plots respectively corresponding to the four segments described above in conjunction with FIG. 7. Each plot shows the SiLU curve within the corresponding segment, a linear curve that approximates the SiLU curve, and a delta curve showing the difference between the actual SiLU curve and the linear curve. In FIG. 8, each SiLU curve is represented by a solid line, each linear curve is represented by a dashed line, and each delta curve is represented by a dash-dotted line.

FIG. 8 shows a comparison between the actual SiLU activation function and its piecewise linear approximations over different sections of the input range. Each plot focuses on a specific segment of the input range, showing how the SiLU function and its linear approximation behave within that segment. The first plot shows the comparison for the input region from −10 to 0. The second plot shows the comparison for the input region from −0.7 to 0. The third plot shows the comparison for the input region from 0 to 0.7. The fourth plot shows the comparison for the input region from 0.7 to 10.

As shown in FIG. 8, the linear curve within each segment is substantially close to the actual SiLU curve within the corresponding segment. The linear approximation of the SiLU activation function can be sufficiently accurate, and SiLU activation function can be approximated using piecewise linear segments across different input regions. By segmenting the input range and using linear approximations, the computational complexity and memory requirements for evaluating the SiLU function can be reduced, making it more efficient for deployment in hardware-constrained environments.

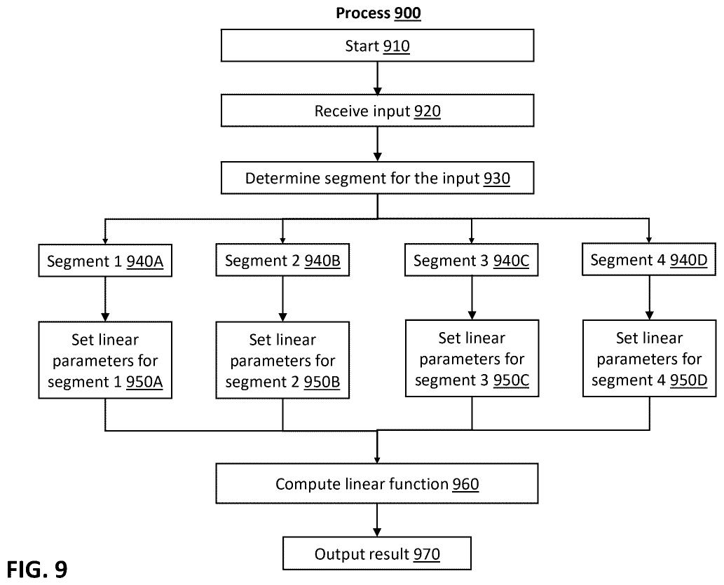

FIG. 9 illustrates a process 900 of approximating a SiLU activation function, in accordance with various embodiments. The process 900 may be performed by a hardware unit that implements a SiLU activator in a DNN, such as the SiLU activator 270 in FIG. 2. An example of the hardware unit is the SiLU unit 116 in FIG. 1. In some embodiments, the process 1000 is performed by the linear unit 142 in the SiLU unit 116. In some embodiments, the process 900 may be performed on values of various data formats or precisions, including 16-bit numbers, such as FP16 numbers.

The process 900 starts in Step 910. For instance, the SiLU unit 116 may receive a control signal indicating the start of approximating the SiLU activation function. The control signal may be received from the flow control unit 111 in FIG. 1. The SiLU unit 116 receives input in Step 920. In an example, the input value is in the FP16 data format. FP stands for floating-point. In other embodiments, the input value may have a different data format or precision. The SiLU unit 116 determines segment for the input in Step 930. In some embodiments, the SiLU unit 116 may determine which segment the input falls into based on the value of the input and the range of the segment. As an example, there are four segments 940A-940D. The SiLU unit 116 may select one of the four segments 940A-940D as the segment of the input.

In embodiments where the SiLU unit 116 selects the segment 940A as the segment of the input, the SiLU unit 116 then sets linear parameters for the segment 940A in Step 950A. In embodiments where the SiLU unit 116 selects the segment 940B as the segment of the input, the SiLU unit 116 then sets linear parameters for the segment 940B in Step 950B. In embodiments where the SiLU unit 116 selects the segment 940C as the segment of the input, the SiLU unit 116 then sets linear parameters for the segment 940C in Step 950C. In embodiments where the SiLU unit 116 selects the segment 940D as the segment of the input, the SiLU unit 116 then sets linear parameters for the segment 940D in Step 950D. The linear parameters of a segment may include a slope and an intercept. Different segments may have different slope or intercept. In some embodiments, the linear parameters of the segments 940A-940D may be stored in a memory included in or otherwise associated with the SiLU unit 116. The linear parameters of the segments 940A-940D may be precomputed, e.g., by a compiler.

The SiLU unit 116 computes linear function in Step 960. The linear function may have been predefined as y=a×x+b, where a denotes the slope and b denotes the intercept. The SiLU unit 116 outputs result in Step 970. The result is the output of the linear function and used as an output of the SiLU activation function for the input. The result may be referred to as an approximated output of the SiLU activation function.

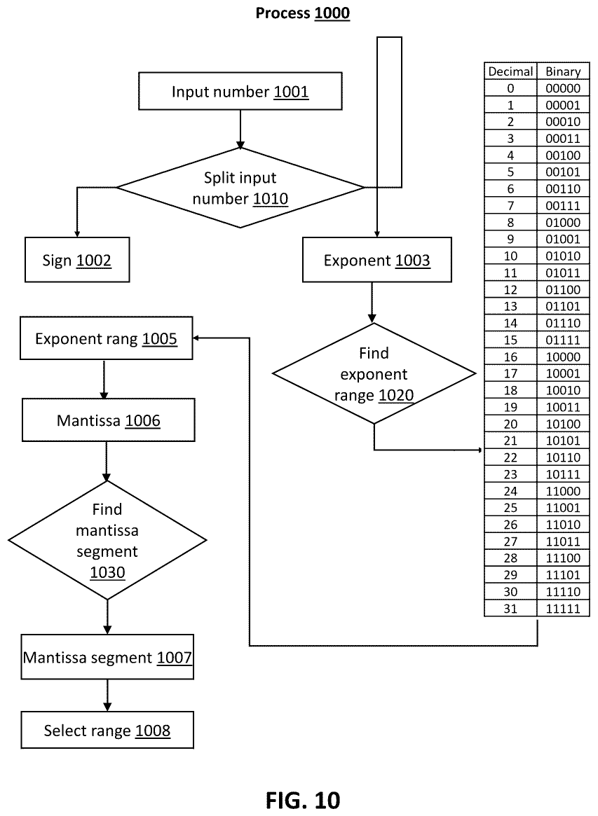

FIG. 10 illustrates a process 1000 of segmentation and range selection, in accordance with various embodiments. The process 1000 may be performed by a hardware unit that implements a SiLU activator in a DNN, such as the SiLU activator 270 in FIG. 2. An example of the hardware unit is the SiLU unit 116 in FIG. 1. In some embodiments, the process 1000 is performed by the linear unit 142 in the SiLU unit 116. In some embodiments, the process 1000 may be performed as part of approximating a SiLU activation function. For the purpose of illustration, the description below regarding the process 1000 is based on an input number 1001 that is a FP16 value. The binary of the input number 1001 is 0b0011110000000001. In other embodiments, the process 1000 may be performed on input numbers having other data formats or precisions.

The SiLU unit 116 splits the input number 1001 in Step 1010. For instance, the input number 1001 is split into a sign 1002, an exponent 1003, and a mantissa 1006. The sign 1002 may have one bit. The exponent 1003 may have 5 bits. The mantissa 1006 may have 10 bits. In the example where the input number 1001 is FP16 number 0b0011110000000001, the sign 1002 is 0, the exponent 1003 is 0111, and the mantissa 1006 is 0000000001.

The SiLU unit 116 also finds an exponent range 1005 in Step 1020 based on the exponent 1003. The SiLU unit 116 use 32 predetermined exponent ranges, which are in the table in FIG. 10. The SiLU unit 116 identifies the exponent range 1005 from the predetermined exponent ranges based on the exponent 1003. In the example above, the exponent 1003 in binary is 01111, which equals 15 in decimal. The exponent range 1005 is 15.

The SiLU unit 116 also finds mantissa segment 1007 in Step 1030 based on the exponent range 1005 and mantissa 1006. In some embodiments, the SiLU unit 116 may divide the exponent range 1005 into a set of mantissa segments based on the mantissa 1006. The SiLU unit 116 may then select one of the mantissa segments based on the mantissa 1006. The mantissa segments may be stored in a memory included in or otherwise associated with the SiLU unit 116. There may be a set of mantissa segments for each exponent range. In the example of FIG. 10, there may be 32 sets of segments corresponding to the 32 exponent ranges, respectively. In an example, the set of mantissa segments for the exponent range 15 include Segments 0-15. Segment 0 is 0000000000-0000001111; Segment 1 is 0000010000-0000011111; Segment 2 is 0000100000-0000101111; Segment 3 is 0000110000-0000111111; Segment 4 is 0001000000-0001001111; Segment 5 is 0001010000-0001011111; Segment 6 is 0001100000-0001101111; Segment 7 is 0001110000-0001111111; Segment 8 is 0010000000-00010001111; Segment 9 is 0010010000-0010011111; Segment 10 is 0010100000-0010101111; Segment 11 is 0010110000-0010111111; Segment 12 is 0011000000-0011001111; Segment 13 is 0011010000-0011011111; Segment 14 is 0011100000-0011101111; and Segment 15 is 0011110000-0011111111.

As described above, the mantissa 1006 in binary is 0000000001. The SiLU unit 116 may identify which segment of Segments 0-15 the mantissa 1006 falls into. In the above example, the SiLU unit 116 determines that the mantissa 1006 falls into Segment 0 because it lies within the range 0000000000-0000011111. The SiLU unit 116 select range for the input number 1001 based on the mantissa segment 1007. The range may be a segment or input region of the input range of the SiLU activation function.

With the process 1000, the SiLU unit 116 can isolate the nonlinear component of the SiLU activation function and handle the input range efficiently. The SiLU unit 116 can segment an input based on its 5-bit exponent, resulting in 32 possible exponent ranges. Each exponent range is then subdivided into 16 segments based on the 10-bit mantissa. Within each segment, linear approximations can be used to model the SiLU function using FP8 coefficients and biases, minimizing memory usage. For each segment, a linear approximation of the form Approximation(x)=Coefficient×x+Bias is used. Coefficients and biases may be stored as FP8 values to minimize memory usage and simplify computations. These linear parameters may be stored in sequential ROMs for fast retrieval.

FIG. 11 illustrates linear approximation of a symmetric function, in accordance with various embodiments. The symmetric function may be a component of a SiLU activation function. For instance, the symmetric function is a SiLU−ReLU function, which is nonlinear. The symmetric function is represented by a curve 1110 in FIG. 11. In the embodiments of FIG. 11, the SiLU−ReLU function is approximated using linear functions represented by linear curves 1120A-1120D.

The input range of the SiLU−ReLU function, which may be the same as the input range of the SiLU activation function, is partitioned into four segments 1125A-1125D. In the example of FIG. 11, the segment 1125A is the range from −10.0 to −5.0, the segment 1125B is the range from −5.0 to 0.0, the segment 1125C is the range from −0.0 to 5.0, and the segment 1125D is the range from 5.0 to 10.0. In other embodiments, the input range of the SiLU−ReLU function may be divided into fewer, more, or different segments.

The linear functions represented by linear curves 1120A-1120D correspond to the four segments 1125A-1125D, respectively. In some embodiments, parameters of the linear functions are predetermined and may be stored in a memory, such as a ROM. The ROM may be a sequential ROM in some embodiments. Each linear function is used to approximate the SiLU−ReLU function within the corresponding segment. In some embodiments,

FIG. 12 illustrates another linear approximation of a symmetric function, in accordance with various embodiments. The symmetric function may be a component of a SiLU activation function. For instance, the symmetric function is a SiLU−ReLU function, which is nonlinear. Compared with the embodiments of FIG. 11, the input range in the embodiments of FIG. 12 is divided into more segments. For instance, there are 32 segments corresponding to 32 possible exponent ranges, respectively, for the SiLU−ReLU function. The actual SiLU−ReLU function is represented by the solid curve in FIG. 12, and the linear functions approximating the SiLU−ReLU function are represented by dash lines in FIG. 12. Different from the linear approximation shown in FIG. 11, the linear approximation shown in FIG. 12 is more accurate as the difference between the linear curves and the actual SiLU−ReLU curve is significantly smaller. The system can be implemented for various floating-point data types, including FP16. The range of the segmentation may be different for different data types, making any numerical input be routed into the corresponding segment which fits the data type.

In some embodiments, segmentation and range selection for linear approximation of the SiLU−ReLU function (e.g., the linear approximation described above in conjunction with FIG. 11 or FIG. 12) may be performed using the segmentation and range selection techniques described above in conjunction with FIGS. 9 and 10.

In some embodiments, the SiLU unit 116 (e.g., the add unit 143 in the SiLU unit 116) may also correct the error from the approximation. For each segment, the difference between the actual SiLU(x)−ReLU(x) values and the linear approximations may be estimated. For instance, the maximum error per segment, which may vary (e.g., 0, 1, 2, 4, or 8 bits), may be determined. The SiLU unit 116 may store the error correction data indicating the maximum error per segment in a memory (e.g., the ROM 144 in the SiLU unit 116). The error correction data may be precomputed/predetermined offline, e.g., by a compiler before the execution of the DNN. During runtime, the SiLU unit 116 may retrieve the error correction data to correct the linear approximation of the SiLU−ReLU function.

The error correction data may include one or more error correction values. In some embodiments, the error correction data may include an error correction value for each segment of the input range of the SiLU activation function. For example, the error correction value of a segment may be the largest delta value between the actual output of the SiLU(x)−ReLU(x) function and the output of the linear function approximating the SiLU(x)−ReLU(x) function within the segment. As another example, the error correction value of a segment may be the average delta value between the actual output of the SiLU(x)−ReLU(x) function and the output of the linear function approximating the SiLU(x)−ReLU(x) function within the segment. In other embodiments, each segment may have multiple error correction values, and each error correction value may correspond to a particular x or a particular range of x within the segment. To correct a linear approximation result, the SiLU unit 116 may sum the linear approximation result with the corresponding error correction value. This sum may be the final linear approximation result or corrected linear approximation result. In an example, the corrected linear approximation result may be denoted as y=a×x+b+c, where a and b are the linear parameters of the linear function, and c is the error correction value.

FIG. 13 illustrates an embedding dot unit 1300, in accordance with various embodiments. The embedding dot unit 1300 may be a hardware implementation of embedding computations in a DNN model. The embedding dot unit 1300 may be part of an embedding die, such as the embedding die 120 in FIG. 1. The embedding dot unit 1300 may be an example of the embedding dot unit 121 in FIG. 1.

As shown in FIG. 13, the embedding dot unit 1300 includes a multiplier unit 1310, an adder unit 1320, and a sampler 1330. In other embodiments, the embedding dot unit 1300 may include fewer, more, or different components. The multiplier unit 1310 may perform elements dot product operation between an embedding vector (e.g., FP8 embedding vector) and a weights vector (e.g., FP6 weights vector read from sequential ROM) every cycle. The multiplier unit 1310 includes a plurality of weights multipliers. In an example of FIG. 13, the embedding dot unit 1300 may include 4,096 weights multipliers: weights multiplier #1 through weights multiplier #4,096. The weights multipliers may perform multiplication in parallel. The outputs (e.g., 4096 outputs) may be added together by the adder unit 1320.

In the example of FIG. 13, the adder unit 1320 includes 4,095 adders. These adders are arranged in a tree or hierarchical structures. In some embodiments, the adder unit 1320 may use a special fixed-point adder with a relatively large number of bits (e.g., 20 bits, 21 bits, . . . 32 bits). The 4,095 adders may be arranged in 13 tiers. A tier is a level in the tree structure. The first tier includes 2,048 adders, for instance. Each adder in the first tier sums two products from two weights multipliers, respectively. Each adder in the second tier sums the outputs of two adders in the first tier. Each adder in the third tier sums the outputs of two adders in the second tier. This continues till adder #4095 is reached. The adder in the 13^{th} tier outputs the final sum, which may be a 33-bit number, which is then provided to the sampler 1330. The sampler 1330 may be a FP16 sampler. The sampler 1330 may resample the final sum into a floating-point representation. The embedding dot unit 1300 may generate an FP16 output. Using a large number of bits in the adder unit 1320 can prevent overflow during many stages/layers of adding.

FIG. 14 illustrates a sequential ROM 1400, in accordance with various embodiments. Sequence read-only memory is a type of memory storage, utilizing ROMs, that allows data to be read sequentially but not written or modified after the values have been etched onto the ROM. The rest of the ROM can be shut down to reduce power and area. In some embodiments, the sequential ROM 1400 may be a ROM in an embedding die, such as the embedding die 120 in FIG. 1.

For the purpose of illustration, the sequential ROM 1400 in FIG. 14 has six word lines. The sequential ROM 1400 can power up an active current word line and an active next word line at a time, while other word lines can be powered down. The active current word line refers to the word line having data being used or processed by a circuit to perform an operation during a time slot in the predetermined timing sequence. The active next word line refers to the word line having data being used or processed by the circuit to perform an operation during a further/next time slot in the predetermined timing sequence. The sequential ROM 1400 can power down the rest of the word lines, or the rest of the word lines in the sequential ROM 1400 can remain powered down. At the next clock or time slot, the active current word line is powered down, the active next word line is already powered up, and a further active next word line is powered up. At every clock or time slot, two word lines may be powered up in the sequential ROM 1400. The two active word lines that are powered up may get moved by one word line down the sequential ROM at every clock or time slot.

In some embodiments, one or more sequential ROMs may be provided on the chip to store various weight matrices for a transformer model:

| Num. Lines | Layer | Matrix |
|---|---|---|
| 16 | 0 | W_{Q} |
| 4 | 0 | W_{K} |
| 4 | 0 | W_{V} |
| 16 | 0 | W_{O} |
| 112 | 0 | W₁ |
| 56 | 0 | W₂ |
| . . . | . . . | . . . |
| 16 | 31 | W_{Q} |
| 4 | 31 | W_{K} |
| 4 | 31 | W_{V} |
| 16 | 31 | W_{O} |
| 112 | 31 | W₁ |
| 56 | 31 | W₂ |
| 16 | 31 | W_{Q} |
| 501 | — | W_{cts} |

In some embodiments, an IC device implementing a DNN may have 1,048,576 ROMs (e.g., sequential ROMs) for storing weights. A ROM may hold weights in FP6 format. A ROM output may be a 6-bit value. A weights ROM may hold a specific weight matrix column, since a weights ROM can output a single number out of the 4096-element vector being multiplied in the EDU. A weights ROM may hold one of 256 weight matrix rows, e.g., when there are 256 embedding dot units working in parallel and producing 256 numbers per clock cycle. A ROM may hold matrix rows 1, 257, . . . , and another ROM can hold matrix rows 2, 258, and so forth. In some cases, a weights ROM may hold elements from (all) weights matrices in (all) layers, since a weights ROM sequentially outputs the number the matrix multiplier is using for (all) transformers and matrices, as the weights multipliers are shared across all layers and weights matrices. The weights ROM may hold (only) the linear layers' weights. There may be one or more dedicated ROMs for the embedder unit and layer normalizer unit.

FIG. 15 illustrates an attention multiplier unit 1500 with a sequential read/write memory, in accordance with various embodiments. The attention multiplier unit 1500 may be a hardware implementation of attention multiplication operations in a DNN. The attention multiplier unit 1500 may be part of an attention die, such as the attention die 130 in FIG. 1.

In the embodiments of FIG. 15, the attention multiplier unit 1500 includes sequential read/write memories. A sequential read/write memory may involve using an SRAM in a special configuration that it is not dynamically readable but is built up sequentially to reduce power and area. As shown in FIG. 15, the sequential read/write memories in the attention multiplier unit 1500 are sequential read SRAMs. An SRAM that can be read sequentially or written sequentially has drastically simplified logic and circuitry for reads or writes. A sequential read/write memory can be used with or in an attention dot unit to supply weights to the attention multiplier unit 1500. In one implementation, the attention dot unit having the attention multiplier unit 1500 may receive an input number and multiplies it by a number from SRAM (e.g., sequential read/write memory) every clock cycle. 64 SRAMs may be used to store the 32 layers and K vs. V separately, so the SRAM can read lines sequentially.

According to one aspect, the sequential read/write memory may be referred to as key-value SRAM (KV SRAM), which can store data in key-value pairs. KV SRAM can enable storing the attention history (e.g., cached keys and values) of a transformer block. In some embodiments, the attention dot unit may receive an input number and multiplies it by a number from SRAM in every clock cycle. 64 SRAMs are used to store the 32 layers and K vs. V separately, so the SRAM can read lines sequentially.

In some embodiments, a sequential read/write memory may store a KV cache for the DNN. To improve computational efficiency, one or more KV caches can be included on chip with the additional dot unit(s) to enhance the performance of the model by temporarily storing frequently accessed data. Keys and values computed in the attention mechanism can be cached to allow for rapid retrieval of information. In some embodiments, the key may represent a unique identifier for a specific input or query, while the value may include the corresponding output or computational result. This caching mechanism deals with dynamic data, and thus uses read/write memory, such as SRAM. The KV cache can significantly reduce latency and computational overhead by avoiding redundant calculations and data fetching, thereby improving the efficiency and responsiveness of the model during inference. Because the cached keys and values can be written and read sequentially during inference, the SRAM implementation can be simplified by restricting reads and writes to be done in a sequential manner (obviating circuits that allow for random-access).

In some embodiments, the queries, keys, or values may be FP16 values. The attention multiplier unit 1500 may receive a K/V control signal, layer control signal, SRAM read control signal, SRAM write control signal, SRAM line to write control signal, store Q/QK control signal, on/sleep control signal, other types of control signals, or some combination thereof. The attention multiplier unit 1500 may operate under the control signals. For instance, the decoder may turn on one of the 64 SRAMs based on the layer control signal (which may indicate which layer is being executed) and K/V control signal (which may indicate whether to multiply K or V). A control signal may have 1 bit. In an example where there are 16 attention dot units per head, 32 lines may be used. The output of the attention multiplier unit 1500 may be 32-bit numbers, such as 32-bit fixed-point so adders can use it. In some embodiments, there may be 65,536 instances of the attention multiplier unit 1500 in the IC device. 65,536 equals 32 heads times 16 dots/heads times 128.

In some embodiments, the attention multiplier unit 1500 is included in an attention dot unit to perform multiplication of two numbers (e.g., FP16 value and FP16 value), where one of the two numbers may be read from the sequential read/write memory storing the KV cache. As illustrated, the attention multiplier unit 1500 includes 64 sequential read SRAMs, and a 6-bit decoder. The decoder may turn on one of the 64 sequential read SRAMs to be used. Data may be read from the active sequential read SRAM serially, e.g., line by line. The data the active sequential read SRAM may be multiplied against the input by the FP16 multiplier. Many instances of attention multiplier unit 1500 may be included in an attention dot unit to perform elementwise multiplication, e.g., in parallel. The multiplication results of the instances of the attention multiplier unit 1500 may be summed by a tree adder to form a vector dot product result. The attention dot unit may perform many vector dot products to form a final matrix multiplication result.

Certain aspects of hardware implementing models on silicon are further described in U.S. patent application Ser. No. 19/281,006, filed on Jul. 25, 2025, U.S. patent application Ser. No. 19/275,640, filed on Jul. 21, 2025, and U.S. patent application Ser. No. 19/244,318, filed on Jun. 20, 2025, each of which is hereby incorporated by reference in its entirety.

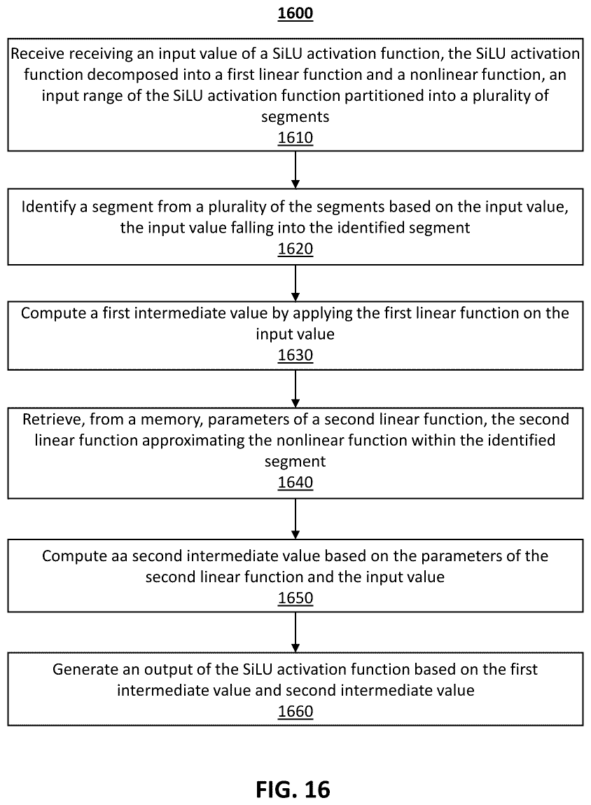

FIG. 16 is a flowchart showing a method 1600 of executing a nonlinear activation function, in accordance with various embodiments. The method 1600 may be performed by the SiLU unit 116 in FIG. 1. Although the method 1600 is described with reference to the flowchart illustrated in FIG. 16, many other methods for nonlinear activation function execution may alternatively be used. For example, the order of execution of the steps in FIG. 16 may be changed. As another example, some of the steps may be changed, eliminated, or combined.

The SiLU unit 116 receives 1610 an input value of a SiLU activation function. The SiLU activation function is decomposed into a first linear function and a nonlinear function. An input range of the SiLU activation function is partitioned into a plurality of segments.

The SiLU unit 116 identifies 1620 a segment from a plurality of the segments based on the input value. The input value falls into the identified segment. In some embodiments, the SiLU unit 116 identifies the segment by identifying an exponent range of the input value and identifying a mantissa segment based on the exponent range and a mantissa of the input value.

The SiLU unit 116 computes 1630 a first intermediate value by applying the first linear function on the input value. In some embodiments, the first linear function is a ReLU activation function.

The SiLU unit 116 retrieves 1640, from a memory, parameters of a second linear function, the second linear function approximating the nonlinear function within the identified segment. In some embodiments, the memory is a sequential ROM.

The SiLU unit 116 computes 1650 a second intermediate value based on the parameters of the second linear function and the input value. In some embodiments, the input value is negative. The SiLU unit 116 computes the second intermediate value by applying the second linear function on an absolute value of the input value to compute an intermediate value and applying a negative sign on the intermediate value to compute the second intermediate value.

The SiLU unit 116 generates 1660 an output of the SiLU activation function based on the first intermediate value and second intermediate value. In some embodiments, the SiLU unit 116 accumulating the first intermediate value and the second intermediate value. In some embodiments, the SiLU unit 116 correcting an error in the second intermediate value

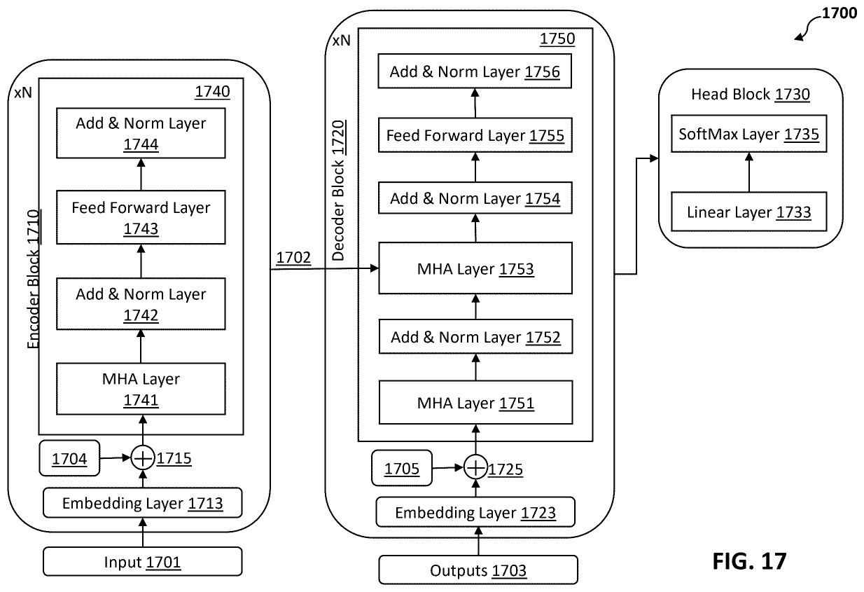

FIG. 17 illustrates an example transformer-based model 1700, in accordance with various embodiments. The transformer-based model 1700 is an example of the DNNs described above. The transformer-based model 1700 may be embedded on a chip. An example of the chip is the IC device 100 in FIG. 1. As shown in FIG. 17, the transformer-based model 1700 includes an encoder block 1710, a decoder block 1720, and a head block 1730. In other embodiment, different or additional components may be included in the transformer-based model 1700. Further, functionality attributed to a component of the transformer-based model 1700 may be accomplished by a different component included in the transformer-based model 1700 or a different model or module.

The encoder block 1710 receives input sequences and generates matrix representations of the input sequences. In the embodiments of FIG. 17, the encoder block 1710 receives an input 1701 and generates an encoder output 1702. The input 1701 may be an input prompt. In some embodiments, the input 1701 may include one or more input tokens, such as words, phrases, sentences, images, audio signals, other types of input tokens, or some combination thereof. In an example, the input 1701 may include a prompt received from a user of the transformer-based model 1700. The prompt may include a question or request made by the user. A word in the prompt may be an input token. In some embodiments, the encoder output 1702 may include one or more vectors that are contextualized representations of the input 1701. Each vector in the encoder output 1702 may represent a token in the input 1701 with contextual understanding.

The encoder block 1710 includes an embedding layer 1713, a positional encoding layer 1715, and a plurality of layers 1740 (individually referred to as “layer 1740”). In other embodiments, the encoder block 1710 may have different, fewer, or more components. Also, the arrangement of the components in the encoder block 1710 may be different from the arrangement shown in FIG. 17. For the purpose of illustration, the encoder block 1710 has N layers in FIG. 17, where N is an integer. Each layer 1740 may include one or more neural network operations. The layers 1740 may transform a sequence of embeddings into a representation that encapsulates the learned information from the input 1701. Different layers 1740 may have different internal parameters, e.g., different weights, bias, or other types of internal parameters. In some embodiments, the layers 1740 have identical components. The components in a layer 1740 may be layers and may also be referred to as sub-layers of the layer 1740. As shown in FIG. 17, a layer 1740 includes four sub-layers: a multi-head attention (MHA) layer 1741, an add & norm layer 1742, a feed forward layer 1743, and another add & norm layer 1744.

The decoder block 1720 iteratively generates outputs 1703 using encoded representations generated by the encoder block 1710. The decoder block 1720 includes an embedding layer 1723, a positional encoding layer 1725, and a plurality of layers 1750 (individually referred to as “layer 1750”). For the purpose of illustration, the decoder block 1720 has N layers in FIG. 17, where N is an integer. In the embodiments of FIG. 17, the number of layers 1750 in the decoder block 1720 is the same as the number of layers 1740 in the encoder block 1710. In other embodiments, the number of layers 1750 in the decoder block 1720 may be different from the number of layers 1740 in the encoder block 1710. Each layer 1750 may include one or more neural network operations. Different layers 1750 may have different internal parameters. In some embodiments, the layers 1750 may have identical components. The components in a layer 1750 may be layers and may also be referred to as sub-layers of the layer 1750. As shown in FIG. 17, a layer 1750 includes six sub-layers: an MHA layer 1751, an add & norm layer 1752, another MHA layer 1753, another add & norm layer 1754, a feed forward layer 1755, and another add & norm layer 1756.

In some embodiments, a sequence of inference stages is performed in the decoder block 1720 using encoder outputs, e.g., the encoder output 1702. A matrix may be predicted through each inference stage. The outputs 1703 may include a plurality of matrices. Each matrix may be further processed in the head block 1730 to predict a token. The plurality of matrices may be used to predict a sequence of tokens. For the first inference stage, the decoder block 1720 may receive one or more start tokens as input tokens and compute a first matrix from the input tokens and the output of the encoder block 1710. The first matrix may be used by the head block 1730 to predict a first token. The predicted token may be used as a new input token, in addition to the start token(s), in the second inference stage. Similarly, a second token may be predicted through the second inference stage and may be used in the third inference stage. This iteration may continue till all the inference stages are complete.

The head block 1730 receives the output of the decoder block 1720 and processes it in a linear layer 1733 and a SoftMax layer 1735. A linear operation may be performed on the output of the decoder block 1720 in the linear layer 1733. The linear operation may include a multiplication of the output of the decoder block 1720 with a weight matrix. The output of the linear layer 1733 may be a vector. In some embodiments, the head block 1730 may function as a classifier. The number of data elements in the vector computed in the linear layer 1733 may depend on the number of classes involved. In an example where there are M classes, where M is an integer, the vector computed in the linear layer 1733 may have M data elements representing the prediction for the M classes, respectively.

The output of the linear layer 1733 may be input into the SoftMax layer 1735. A SoftMax function may be applied on the output of the linear layer 1733 to compute probability scores. A probability score may have a value in the range from 0 to 17. In some embodiments, a probability value is computed for each data element in the vector computed in the linear layer 1733. The highest one of the probability scores may be the key. The corresponding index of the key may point to the token that the transformer-based model 1700 predicts as the next in the sequence. The final output of the transformer-based model 1700 may be the sequence of predicted tokens. In some embodiments, the head block 1730 may be a language modeling head.

An embedding layer (e.g., the embedding layer 1713 or the embedding layer 1723) converts an input of the embedding layer (e.g., the input 1701 or the outputs 1703) into one or more embeddings. An embedding may be a vector, which is also referred to as an embedding vector or a vector embedding. The vector embedding may include a sequence of data elements. In some embodiments, the embedding layer 1713 may generate a plurality of embeddings, each of which may be converted from a different input token in the input 1701. The embeddings may capture the semantic meaning of the tokens in the input 1701. The embeddings may be numerical representations that capture the relationships or meanings of words, phrases, or other data types. In an example where the input 1701 is a prompt including a sequence of words, the embedding layer 1713 may generate an embedding from each word in the input 1701. The embedding layer 1723 in the decoder block 1720 may generate a plurality of embeddings from tokens received by the decoder block 1720 in a similar manner as the embedding layer 1713.

A positional encoding layer (e.g., the positional encoding layer 1715 or the positional encoding layer 1725) performs positional encoding on embeddings generated in the corresponding embedding layer. In some embodiments, the positional encoding layer may apply one or more positional encoding vectors (e.g., a positional encoding vector 1704 or positional encoding vector 1705) on vector embeddings from the corresponding embedding layer to generate new vector embeddings that represent the embeddings with positional context. The positional encoding vector may encode information about the position of the embedding in a sequence of embeddings. In some embodiments, the positional encoding layer performs an addition operation on a positional encoding vector and a vector embedding. The addition operation may be elementwise addition. The positional encoding layer may output an embedding matrix that includes the vector embeddings computed in the positional encoding layer.

An MHA layer (e.g., the MHA layer 1741, the MHA layer 1751, or the MHA layer 1753) may implement a multi-head attention mechanism, which may be a multi-head self-attention mechanism or a multi-head cross-attention mechanism. In some embodiments, the MHA layer 1741 or the MHA layer 1751 may implement a self-attention mechanism. For self-attention, the queries, keys, and values may come from the same place. For instance, for the MHA layer 1741, the queries, keys, and values may all come from the positional encoding layer 1715. For the MHA layer 1751, the queries, keys, and values may all come from the positional encoding layer 1725. The self-attention mechanism may enable the transformer-based model 1700 to relate each token with other tokens. The MHA layer may compute attention scores from embeddings generated in the corresponding positional encoding layer. In some embodiments, the MHA layer may receive one or more queries, one or more keys, and one or more values. In some embodiments, the MHA layer has a number of heads that receive different linearly projected versions of the queries, keys, and values and produce outputs in parallel that are then used to generate the final result.

In some embodiments, the queries, keys, and values input into the MHA layer 1741 may be computed from vector embeddings generated by the positional encoding layer 1715. The queries, keys, and values input into the MHA layer 1751 may be computed from vector embeddings generated by the positional encoding layer 1725. A query, key, or value may be a vector the represents a token in a sequence. In some embodiments, a query matrix Q∈ [symbol] may be computed by multiply an embedding matrix X∈R^{N×d} (e.g., an embedding matrix computed in a positional encoding layer) with a weight matrix W_{q}∈ [symbol] , where d is the dimension of a vector embedding, N is the number of vector embeddings in the embedding matrix, and h is the number of attention heads. Each row in the query matrix may be a query. A key matrix K∈ [symbol] may be computed by multiple an embedding matrix X∈R^{N×d} (e.g., an embedding matrix computed in a positional encoding layer) with a weight matrix Wₖ∈ [symbol] . Each row in the key matrix may be a key. A value matrix V∈ [symbol] may be computed by multiple an embedding matrix X∈R^{N×d} (e.g., an embedding matrix computed in a positional encoding layer) with a weight matrix Wᵥ∈ [symbol] . Each row in the value matrix may be a value.

In some embodiments, the MHA layer 1751 may implement masked multi-head self-attention. The MHA layer 1751 may prevent positions from attending to subsequent positions. For instance, each token in the sequence may not be influenced by future tokens. This masking can ensure that the predictions of a particular position can depend on known outputs at positions before it and not depend on unknown outputs at positions after it.

In some embodiments, the MHA layer 1753 may implement a cross-attention mechanism, such as encoder-decoder cross-attention. The MHA layer 1753 may use outputs from the previous layer (i.e., the add & norm layer 1752) as queries and use outputs from the encoder block 1710 as keys and values. The cross-attention can align the encoder's input with the decoder's, empowering the decoder block 1720 to identify and emphasize the most relevant parts of the encoder's input.

In some embodiments, an MHA layer includes linear layers, a MatMul layer, a scale layer, a SoftMax layer, another MatMul layer, a concatenation layer, and another linear layer. These layers may be arranged in a sequence. The MHA layer may receive three input matrices: a query matrix, a key matrix, and a value matrix, which are inputs of three linear layers, respectively. The linear layers may include matrix multiplication (MatMul) operations. For instance, a first linear layer may perform a multiplication of the query matrix with a weight matrix to compute a first parameter matrix. The first parameter matrix may be denoted as

$${QW}_{i}^{Q} ,$$

where Q is the query matrix and

$${W}_{i}^{Q} ∈ {ℝ}^{{d}_{model} \times {d}_{q}}$$

is the weight matrix. A second linear layer may perform a multiplication of the key matrix with a weight matrix to compute a second parameter matrix. The second parameter matrix may be denoted as

$${KW}_{i}^{K} ,$$

where K is the key matrix and

$${W}_{i}^{K} ∈ {ℝ}^{{d}_{model} \times {d}_{k}}$$

is the weight matrix. A third linear layer may perform a multiplication of the value matrix with a weight matrix to compute a third parameter matrix. The third parameter matrix may be denoted as

$${VW}_{i}^{V} ,$$

where V is the value matrix and

$${W}_{i}^{V} ∈ {ℝ}^{{d}_{model} \times {d}_{k}}$$

is the weight matrix. i may indicate the index of the head. d_{q} is the dimension of a query vector. dₖ is the dimension of a key vector. dᵥ is the dimension of a value vector. In some embodiments, d_{q}=dₖ=dᵥ=d_{model}/h. In some embodiments, the linear layers may be in a linear block of the MHA layer. In some embodiments, the MHA layer may include multiple linear blocks. For instance, the MHA layer includes h linear blocks. The linear blocks may have the same layers as each other. Each linear block may compute three parameter matrices from the query matrix, key matrix, and value matrix, respectively.

The MatMul layer, scale layer, mask layer, SoftMax layer, and MatMul layer may be in an attention block of the MHA layer. The attention block may implement a scaled dot product attention mechanism. In some embodiments, the MHA layer includes a plurality of attention blocks that includes the attention block. For the purpose of illustration, the MHA layer includes h attention blocks. The attention blocks may have the same layers as each other. A linear block and an attention block may constitute a head of the MHA layer. When the MHA layer has h linear blocks and h attention blocks, the MHA layer has h heads. A head may be denoted as

$${head}_{i} = Attention ( {QW}_{i}^{Q} , {KW}_{i}^{K} , {VW}_{i}^{V} ) .$$

A matrix multiplication operation may be performed on parameter matrices in the MatMul layer, which computes a score matrix. In some embodiments, the score matrix may establish the degree of emphasis each token should place on other tokens. The score matrix may include a plurality of scores. Each token may be assigned a score in relation to other tokens within the same time step. A higher score may indicate a higher focus or emphasis. The score matrix may be scaled in the scale layer. In some embodiments, the score matrix is scaled down in the scale layer by dividing the scores in the score matrix by the square root of the dimension of the query vector and the key vector, which may be denoted as \sqrt{dₖ}. The output of the scale layer may be a scaled matrix, which includes adjusted scores. The mask layer may be optional in some embodiments. The mask layer may add an attention mask (which may be an input to the attention block) to the output of the scale layer to mask out some elements in the output of the scale layer. The positions of the masked-out elements may be defined by the attention mask. A SoftMax function may be applied on the scaled matrix in the SoftMax layer to compute an attention weight matrix. The attention weight matrix includes attention weights. The attention weights may be probability values ranging from 0 to 1. The SoftMax function may emphasize high scores while diminishing low scores, which can enhance the model's ability to determine which tokens should get more attention.

In the MatMul layer, a matrix multiplication operation is performed on the attention weight matrix computed in the SoftMax layer and the parameter matrix computed from value matrix in the corresponding linear layer. The result of the matrix multiplication operation is a single-head output matrix, which is an output of the attention block.

When the MHA layer has h attention blocks, there may be h single-head output matrices. The single-head output matrices are concatenated in the concatenation layer to form a concatenated matrix. A linear operation (also referred to as “linear transformation”) is performed on the concatenated matrix using a weight matrix in the linear layer. In some embodiments, the MHA may be denoted as MultiHead(Q,K,V)=Concat(head₁, head₂, . . . , headₙ)W^{O}, where Concat denotes concatenation, and W_{O}∈ [symbol] is the weight matrix in the corresponding linear layer.

An add & norm layer in the transformer-based model 1700, such as the add & norm layer 1742, 1744, 1752, 1754, and 1756, has an addition operation followed by a layer normalization operation. The addition operation may be an addition of the output of the preceding layer and the input of the preceding layer. The preceding layer is a layer that is arranged right before the add & norm layer. For example, the preceding layer of the add & norm layer 1742 is the MHA layer 1741. As another example, the preceding layer of the add & norm layer 1754 is the MHA layer 1753.

Then the layer normalization operation is applied on the result of the addition operation, which may be denoted as LayerNorm(x+sublayer(x)), where LayerNorm denotes layer normalization, x is the input of the preceding layer, and sublayer(x) denotes the output of the preceding layer. In some embodiments, the layer normalization operation may include a sequence of computations. In an example, the layer normalization operation may include a mean computation, which may be denoted as

$${μ}_{x y} = \frac{1}{Z} \times {\sum }_{z = 1}^{Z} {A}_{xyz} ,$$

where A_{xyz} denotes a data element in the input tensor, x may be the positional index of the data element in one of the spatial dimensions, y may be the positional index of the data element in the other one of the spatial dimensions, z may be the positional index of the data element in the channel dimension, and μ_{xy} denotes the output of the mean computation, which may be a 2D matrix. The mean computation may be channel-wise reduction operation. The layer normalization operation may convert μ_{xy} to a 3D tensor μ_{xyz}, e.g., by replicating every data element over z output points.

The layer normalization operation may also include an elementwise subtraction, which may be denoted as D_{xyz}=A_{xyz}−μ_{xyz}. The layer normalization operation may further include a variance computation denoted as

$${σ}_{x y}^{2} = {\sum }_{z = 1}^{Z} {D}_{x y z}^{2}$$

and a division computation denoted as

$${M}_{x y} = \frac{1}{\sqrt{\frac{1}{Z} \times ( {σ}_{x y}^{2} + ϵ \times Z )}} .$$

M_{xy} may be a 2D tensor. The layer normalization operation may also convert M_{xy} to a 3D tensor M_{xyz}, e.g., by replicating every data element over z output points. Further, the layer normalization operation may have an element multiplication denoted as

$${A}_{x y z}^{′} = \frac{{A}_{x y z} - {μ}_{x y z}}{\sqrt{\frac{1}{Z} \times ( {σ}_{x y}^{2} + ϵ )}} = ( {A}_{x y z} - {μ}_{x y z} ) \times \frac{1}{\sqrt{\frac{1}{Z} \times ( {σ}_{x y}^{2} + ϵ )}} = {D}_{x y z} \times {M}_{x y z} .$$

The layer normalization operation may further compute

$${A}_{x y z}^{′′} = {A}_{x y z}^{′} + \frac{{β}_{Z}}{{γ}_{Z}} and L {N}_{x y z} = {A}_{x y z}^{′′} \times {γ}_{Z} . L {N}_{x y z}$$

may be the output of the layer normalization operation.

A feed forward layer (e.g., the feed forward layer 1743 and the feed forward layer 1755) may be a position-wise fully-connected feed forward network. In an example, the feed forward layer may include two linear layers with an activation function in between. An example of the activation function is ReLU.

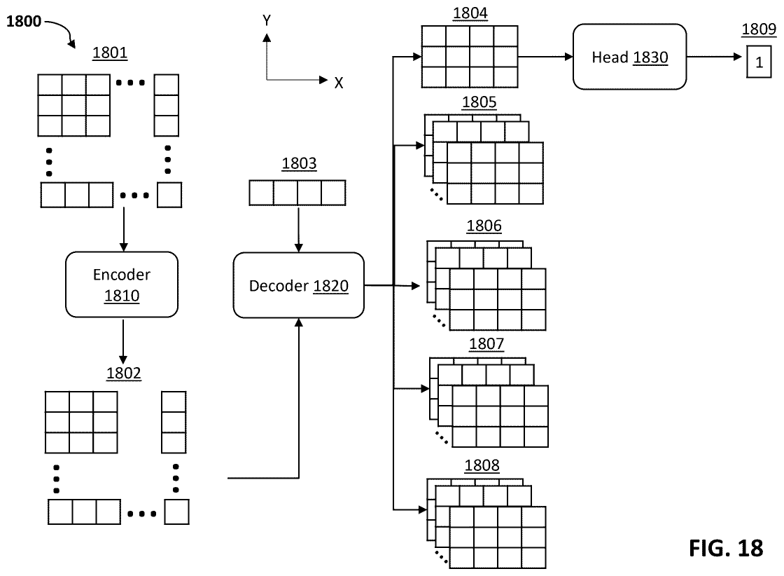

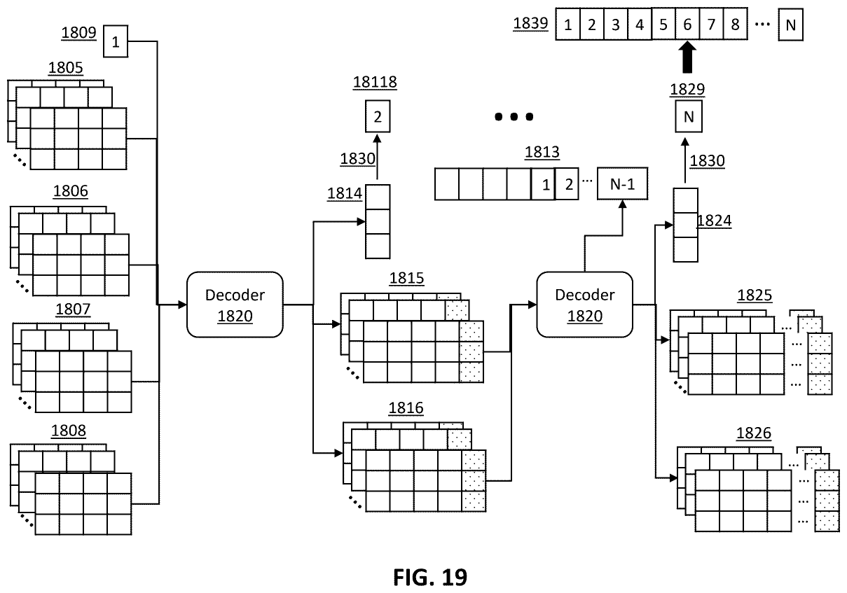

FIGS. 18 and 19 illustrate inferences of a transformer model 1800, in accordance with various embodiments. FIG. 18 illustrates the first inference process of the transformer model 1800, in accordance with various embodiments. The transformer model 1800 includes an encoder 1810, a decoder 1820, and a head 1830. An example of the transformer model 1800 may be the transformer-based model 1700 in FIG. 17. In the embodiments of FIG. 18, the encoder 1810 receives an input tensor 1801. The input tensor 1801 may be a feature map extracted from one or more images, text documents, audio files, videos, other types of data, or some combination thereof. The encoder 1810 generates an output tensor 1802 from the input tensor 1801. The shape of the output tensor 1802 may be denoted as [batch size,SL_{encoder},d_{model}], where SL_{encoder} may be the dimension along the X axis (i.e., the width of the output tensor 1802), and d_{model} may be the dimension along the Y axis (i.e., the height of the output tensor 1802). The encoder 1810 may include a plurality of layers arranged in a sequence, such as the layers inside the encoder 1810 in FIG. 17. The output tensor 1802 is provided to the decoder 1820.

The decoder 1820 receives the output tensor 1802 and an input sequence 1803. The input sequence 1803 may be a sequence of tokens. A token may be a numerical representation of an input signal, such as word, image, audio signal, video signal, etc. The dimension of the input sequence 1803, which may be denoted as SLᵢₙₚᵤₜ, may be the total number of tokens in the input sequence 1803. For the purpose of illustration and simplicity, SLᵢₙₚᵤₜ is 4. In other embodiments, the input sequence 1803 may have a different shape. For instance, the input sequence 1803 may be a 2D tensor. The dimension of the 2D tensor along the X axis may be SLᵢₙₚᵤₜ, while the dimension of the 2D tensor along the Y axis may be a batch size indicating the number of batches in the input sequence 1803.

The decoder 1820 computes an output tensor 1804, a self-attention key tensor 1805, a self-attention value tensor 1806, a cross-attention key tensor 1807, and a cross-attention value tensor 1808. In some embodiments, the shape of the output tensor 1804 may be denoted as [batch size,SLᵢₙₚᵤₜ,d_{model}]. The shape of the self-attention key tensor 1805 or the shape of the self-attention value tensor 1806 may be denoted as N×[batch size,h,SLᵢₙₚᵤₜ,d_{head}], where N is the number of identical layers in the decoder (e.g., the number of layers 850 in the decoder block 820), h is the total number of heads in a MHA layer, and d_{head} is the dimension of a query vector, key vector, or value vector. In some embodiments, d_{model}=h×d_{head}. The shape of the cross-attention key tensor 1807 or the shape of the cross-attention value tensor 1808 may be denoted as N×[batch size,h,SL_{encoder},d_{head}].

The output tensor 1804 may be provided to the head 1830 and the head 1830 outputs a predicted token 1809. The shape of the token 1809 may be denoted as [batch size,1]. For the purpose of illustration and simplicity, batch size is 1 in FIG. 18. In other embodiments, batch size may be a larger number. The predicted token 1809 may be stored in a buffer. In some embodiments, the predicted token 1809 may be used to update the input sequence 1803. For instance, the predicted token 1809 may be added to the right of the input sequence 1803. The updated input sequence may be used as the input sequence in the second inference phase. In the second inference phase, the decoder 1820 may receive the updated input sequence and the output tensor 1802 for predicting another token. The output tensor 1802 may remain the same during inference of the decoder 1820. Certain aspects of subsequent inference processes are described below in conjunction with FIG. 19.

In some embodiments, the self-attention key tensor 1805 and the self-attention value tensor 1806 may be provided to a self-attention layer in the decoder 1820, an example of such a self-attention layer is the MHA layer 151. The self-attention key tensor 1805 may be stored in a self-attention key cache. The self-attention key cache may have the same shape as the self-attention key tensor 1805. The self-attention value tensor 1806 may be stored in a self-attention value cache. The self-attention value cache may have the same shape as the self-attention value tensor 1806.

In some embodiments, the decoder 1820 computes the self-attention key tensor 1805 and the self-attention value tensor 1806 from the input sequence 1803. The input sequence 1803 may be dynamic during inference of the decoder 1820. For instance, a new token may be added to the input sequence 1803 after each inference phase, as described above. As the input sequence 1803 changes, the self-attention key tensor 1805 and the self-attention value tensor 1806 would also change. For instance, the dimension of the self-attention key tensor 1805 or the self-attention value tensor 1806 along the X axis may increase as SLᵢₙₚᵤₜ increases. The self-attention key cache and the self-attention value cache may change during all the inference phases of the decoder 1820 to accommodate the changes in the self-attention key tensor 1805 and the self-attention value tensor 1806.

In some embodiments, the cross-attention key tensor 1807 and the cross-attention value tensor 1806 may be provided to a cross-attention layer in the decoder 1820, an example of such a cross-attention layer is the MHA layer 153. The cross-attention key tensor 1807 may be stored in a cross-attention key cache. The cross-attention key cache may have the same shape as the cross-attention key tensor 1807. The cross-attention value tensor 1808 may be stored in a cross-attention value cache. The cross-attention value cache may have the same shape as the cross-attention value tensor 1808. In some embodiments, the decoder 1820 computes the cross-attention key tensor 1807 and the cross-attention value tensor 1806 from the output tensor 1802 generated in the encoder 1810. As the output tensor 1802 does not change during inference of the decoder 1820, the cross-attention key tensor 1807 and the cross-attention value tensor 1806 may remain the same during all the inference phases of the decoder 1820. The cross-attention key cache and the cross-attention value cache may remain the same during all the inference phases of the decoder 1820.

FIG. 19 illustrates subsequent inference processes of the transformer model 1800, in accordance with various embodiments. In the second inference phase, the decoder 1820 may reuse the self-attention key tensor 1805, self-attention value tensor 1806, cross-attention key tensor 1807, and cross-attention value tensor 1808. The decoder 1820 also receives the predicted token 1809. The decoder 1820 may compute self-attention key vectors from the predicted token 1809 and concatenate the self-attention key vectors with the self-attention key tensor 1805 to generate a new self-attention key tensor 1815. For instance, a self-attention key vector for each head may be added to the right of a self-attention key matrix in the self-attention key tensor 1805, and the self-attention key vector and the self-attention key matrix may correspond to the same head. The elements highlighted with a dot pattern in the self-attention key tensor 1815 are the self-attention key vectors generated from the predicted token 1809.

Similarly, the decoder 1820 may compute self-attention value vectors from the predicted token 1809 and concatenate the self-attention value vectors with the self-attention value tensor 1806 to generate a new self-attention value tensor 1816. For instance, a self-attention value vector for each head may be added to the right of a self-attention value matrix in the self-attention value tensor 1806, and the self-attention value vector and the self-attention value matrix may correspond to the same head. The elements highlighted with a dot pattern in the self-attention value tensor 1816 are the self-attention value vectors generated from the predicted token 1809.

The decoder 1820 also generates an output tensor 1814. The decoder 1820 may generate the output tensor 1814 using the new self-attention key tensor 1815 and new self-attention value tensor 1816. The output tensor 1814 is used by the head 1830 to generate another predicted token 1819. The predicted token 1819 is the output of the transformer model 1800 in the second inference phase.

One or more other subsequent inference processes may be conducted. In each subsequent inference phase, the decoder 1820 receives a token predicted in the previous inference phase, a self-attention key tensor generated in the previous inference phase, a self-attention value tensor generated in the previous inference phase, the cross-attention key tensor 1807, and the cross-attention value tensor 1808. The decoder 1820 may, in the subsequent inference phase, generate a larger self-attention key tensor and a larger self-attention value tensor, in addition to an output tensor which can be used by the head 1830 to predict a new token.

In embodiments where the total number of inference phases is N, the input sequence 1803 is updated to an input sequence 1813 after N−1 inference phases. In the last inference phase (i.e., the Nth inference phase), the decoder 1820 may receive the predicted token generated in the (N−1)th inference phase, the self-attention key tensor generated in the (N−1)th inference phase, the self-attention value tensor generated in the (N−1)th inference phase, the cross-attention key tensor 1807, and the cross-attention value tensor 1808. The decoder 1820 may generate a self-attention key tensor 1825 and a self-attention value tensor 1826 using the predicted token generated in the (N−1)th inference phase, the self-attention key tensor generated in the (N−1)th inference phase, and the self-attention value tensor generated in the (N−1)th inference phase. The dimensions of the self-attention key tensor 1825 or self-attention value tensor 1826 along the X axis is SLᵢₙₚᵤₜ+N. The decoder 1820 also generates an output tensor 1824, which is used by the head 1830 to generate the last predicted token 1829. The N tokens predicted by the transformer model in the N inference phases may constitute an output tensor 1839, which may be the final output of the transformer model.

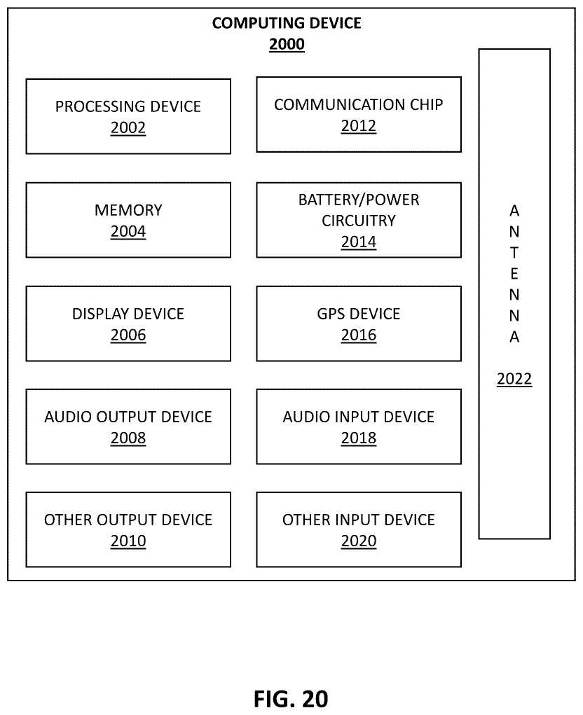

FIG. 20 is a block diagram of an example computing device 2000, in accordance with various embodiments. A number of components are illustrated in FIG. 20 as included in the computing device 2000, but any one or more of these components may be omitted or duplicated, as suitable for the application. In some embodiments, some or all of the components included in the computing device 2000 may be attached to one or more motherboards. In some embodiments, some or all of these components are fabricated onto a single system on a chip (SoC) die. Additionally, in various embodiments, the computing device 2000 may not include one or more of the components illustrated in FIG. 20, but the computing device 2000 may include interface circuitry for coupling to the one or more components. For example, the computing device 2000 may not include a display device 2006, but may include display device interface circuitry (e.g., a connector and driver circuitry) to which a display device 2006 may be coupled. In another set of examples, the computing device 2000 may not include an audio input device 2018 or an audio output device 2008 but may include audio input or output device interface circuitry (e.g., connectors and supporting circuitry) to which an audio input device 2018 or audio output device 2008 may be coupled.

The computing device 2000 may include a processing device 2002 (e.g., one or more processing devices). The processing device 2002 processes electronic data from registers and/or memory to transform that electronic data into other electronic data that may be stored in registers and/or memory. The computing device 2000 may include a memory 2004, which may itself include one or more memory devices such as volatile memory (e.g., DRAM), nonvolatile memory (e.g., ROM, high bandwidth memory (HBM), flash memory, solid state memory, and/or a hard drive. In some embodiments, the memory 2004 may include memory that shares a die with the processing device 2002. In some embodiments, the memory 2004 includes one or more non-transitory computer-readable media storing instructions executable to perform operations for DNN execution, such as operations performed by the IC device 100 in FIG. 1 or the method 1600 in FIG. 16. The instructions stored in the one or more non-transitory computer-readable media may be executed by the processing device 2002.

In some embodiments, the computing device 2000 may include a communication chip 2012 (e.g., one or more communication chips). For example, the communication chip 2012 may be configured for managing wireless communications for the transfer of data to and from the computing device 2000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 2012 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 2012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 2012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 2012 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 2012 may operate in accordance with other wireless protocols in other embodiments. The computing device 2000 may include an antenna 2022 to facilitate wireless communications and/or to receive other wireless communications (such as AM or FM radio transmissions).

In some embodiments, the communication chip 2012 may manage wired communications, such as electrical, optical, or any other suitable communication protocols (e.g., the Ethernet). As noted above, the communication chip 2012 may include multiple communication chips. For instance, a first communication chip 2012 may be dedicated to shorter-range wireless communications such as Wi-Fi or Bluetooth, and a second communication chip 2012 may be dedicated to longer-range wireless communications such as global positioning system (GPS), EDGE, GPRS, CDMA, WiMAX, LTE, EV-DO, or others. In some embodiments, a first communication chip 2012 may be dedicated to wireless communications, and a second communication chip 2012 may be dedicated to wired communications.

The computing device 2000 may include battery/power circuitry 2014. The battery/power circuitry 2014 may include one or more energy storage devices (e.g., batteries or capacitors) and/or circuitry for coupling components of the computing device 2000 to an energy source separate from the computing device 2000 (e.g., AC line power).

The computing device 2000 may include a display device 2006 (or corresponding interface circuitry, as discussed above). The display device 2006 may include any visual indicators, such as a heads-up display, a computer monitor, a projector, a touchscreen display, a liquid crystal display (LCD), a light-emitting diode display, or a flat panel display, for example.

The computing device 2000 may include an audio output device 2008 (or corresponding interface circuitry, as discussed above). The audio output device 2008 may include any device that generates an audible indicator, such as speakers, headsets, or earbuds, for example.

The computing device 2000 may include an audio input device 2018 (or corresponding interface circuitry, as discussed above). The audio input device 2018 may include any device that generates a signal representative of a sound, such as microphones, microphone arrays, or digital instruments (e.g., instruments having a musical instrument digital interface (MIDI) output).

The computing device 2000 may include a GPS device 2016 (or corresponding interface circuitry, as discussed above). The GPS device 2016 may be in communication with a satellite-based system and may receive a location of the computing device 2000, as known in the art.

The computing device 2000 may include another output device 2010 (or corresponding interface circuitry, as discussed above). Examples of the other output device 2010 may include an audio codec, a video codec, a printer, a wired or wireless transmitter for providing information to other devices, or an additional storage device.

The computing device 2000 may include another input device 2020 (or corresponding interface circuitry, as discussed above). Examples of the other input device 2020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 2000 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 2000 may be any other electronic device that processes data.

The following paragraphs provide various examples of the embodiments disclosed herein.

Example 1 provides an IC device, including an activator unit to implement a nonlinear activation function in a neural network model, the activator unit to approximate the nonlinear activation function by computing one or more linear functions; a dot unit to implement one or more matrix multiplication operations in the neural network model, the dot unit including one or more adders and one or more multipliers; and a flow control unit to orchestrate operations of the activator unit and the dot unit in accordance with a timing sequence of neural network operations in the neural network model.

Example 2 provides the IC device of example 1, in which the activator unit includes another activator unit to implement an activation function of a different type from the nonlinear activation function; a linear unit to compute the one or more linear functions; and a memory to store parameters of the one or more linear functions.

Example 3 provides the IC device of example 2, in which the nonlinear activation function is a SiLU activation function, and the activation function of the different type is a ReLU activation function.

Example 4 provides the IC device of example 3, in which the memory is a sequential ROM.

Example 5 provides the IC device of any one of examples 1-4, in which the nonlinear activation function is decomposed into a linear function and a symmetric function, in which the one or more linear functions are an approximation of the symmetric function.

Example 6 provides the IC device of any one of examples 1-5, in which computing the one or more linear functions includes identifying a linear function for an input value and applying the identified linear function on the input value.

Example 7 provides the IC device of any one of examples 1-6, in which the one or more linear functions include linear functions with different parameters, in which different ones of the linear functions correspond to different segments of an input range of the nonlinear activation function.

Example 8 provides the IC device of example 7, in which the activator unit is to select one of the different segments for an input value based on an exponent or mantissa of the input value.

Example 9 provides the IC device of any one of examples 1-8, in which the activator unit is to apply the one or more linear function on an absolute value of a negative input value to compute an intermediate value and to apply a negative sign on the intermediate value to compute an output value.

Example 10 provides the IC device of any one of examples 1-9, in which the activator unit to approximate the nonlinear activation function further by applying an error correction value on a result of the one or more linear functions.

Example 11 provides one or more non-transitory computer-readable media storing instructions executable to perform operations, the operations including receiving an input value of an activation function in a neural network model, the activation function decomposed into a first linear function and a nonlinear function, an input range of the activation function partitioned into a plurality of segments; identifying a segment from a plurality of the segments based on the input value, the input value falling into the identified segment; computing a first intermediate value by applying the first linear function on the input value; retrieving, from a memory, parameters of a second linear function, the second linear function approximating the nonlinear function within the identified segment; computing a second intermediate value based on the parameters of the second linear function and the input value; and generating an output of the activation function based on the first intermediate value and second intermediate value.

Example 12 provides the one or more non-transitory computer-readable media of example 11, in which the activation function is a SiLU activation function.

Example 13 provides the one or more non-transitory computer-readable media of example 11 or 12, in which the first linear function is a ReLU activation function.

Example 14 provides the one or more non-transitory computer-readable media of any one of examples 11-13, in which the memory is a sequential ROM.

Example 15 provides the one or more non-transitory computer-readable media of any one of examples 11-14, in which identifying the segment includes identifying an exponent range of the input value; and identifying a mantissa segment based on the exponent range and a mantissa of the input value.

Example 16 provides the one or more non-transitory computer-readable media of any one of examples 11-15, in which the input value is negative, in which computing the second intermediate value includes applying the second linear function on an absolute value of the input value to compute an intermediate value; and applying a negative sign on the intermediate value to compute the second intermediate value.

Example 17 provides the one or more non-transitory computer-readable media of any one of examples 11-16, in which generating the output of the activation function includes accumulating the first intermediate value and the second intermediate value.

Example 18 provides the one or more non-transitory computer-readable media of example 17, in which generating the output of the activation function further includes correcting an error in the second intermediate value.

Example 19 provides an apparatus, including a computer processor for executing computer program instructions; and a non-transitory computer-readable memory storing computer program instructions executable by the computer processor to perform operations, the operations including receiving an input value of an activation function, the activation function decomposed into a first linear function and a nonlinear function, an input range of the SiLU activation function partitioned into a plurality of segments, identifying a segment from a plurality of the segments based on the input value, the input value falling into the identified segment, computing a first intermediate value by applying the first linear function on the input value, retrieving, from a memory, parameters of a second linear function, the second linear function approximating the nonlinear function within the identified segment; computing a second intermediate value based on the parameters of the second linear function and the input value, and generating an output of the activation function based on the first intermediate value and second intermediate value.

Example 20 provides the apparatus of example 19, in which the activation function is a SiLU activation function.

Example 21 provides the apparatus of example 19 or 20, in which the first linear function is a ReLU activation function.

Example 22 provides the apparatus of any one of examples 19-21, in which the memory is a sequential ROM.

Example 23 provides the apparatus of any one of examples 19-22, in which identifying the segment includes identifying an exponent range of the input value; and identifying a mantissa segment based on the exponent range and a mantissa of the input value.

Example 24 provides the apparatus of any one of examples 19-23, in which the input value is negative, in which computing the second intermediate value includes applying the second linear function on an absolute value of the input value to compute an intermediate value; and applying a negative sign on the intermediate value to compute the second intermediate value.

Example 25 provides the apparatus of any one of examples 19-24, in which generating the output of the activation function includes correcting an error in the second intermediate value; and accumulating the first intermediate value and the second intermediate value after correcting the error.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art can recognize. These modifications may be made to the disclosure in light of the above detailed description.

1. An integrated circuit (IC) device, comprising:
an activator unit to implement a nonlinear activation function in a neural network model, the activator unit to approximate the nonlinear activation function by computing one or more linear functions;
a dot unit to implement one or more matrix multiplication operations in the neural network model, the dot unit comprising one or more adders and one or more multipliers; and
a flow control unit to orchestrate operations of the activator unit and the dot unit in accordance with a timing sequence of neural network operations in the neural network model.

2. The IC device of claim 1, wherein the activator unit comprises:
another activator unit to implement an activation function of a different type from the nonlinear activation function;
a linear unit to compute the one or more linear functions; and
a memory to store parameters of the one or more linear functions.

3. The IC device of claim 2, wherein the nonlinear activation function is a sigmoid linear unit activation function, and the activation function of the different type is a rectified linear unit activation function.

4. The IC device of claim 3, wherein the memory is a sequential read-only memory.

5. The IC device of claim 1, wherein the nonlinear activation function is decomposed into a linear function and a symmetric function, wherein the one or more linear functions are an approximation of the symmetric function.

6. The IC device of claim 1, wherein computing the one or more linear functions comprises identifying a linear function for an input value and applying the identified linear function on the input value.

7. The IC device of claim 1, wherein the one or more linear functions include linear functions with different parameters, wherein different ones of the linear functions correspond to different segments of an input range of the nonlinear activation function.

8. The IC device of claim 7, wherein the activator unit is to select one of the different segments for an input value based on an exponent or mantissa of the input value.

9. The IC device of claim 1, wherein the activator unit is to apply the one or more linear function on an absolute value of a negative input value to compute an intermediate value and to apply a negative sign on the intermediate value to compute an output value.

10. The IC device of claim 1, wherein the activator unit to approximate the nonlinear activation function further by applying an error correction value on a result of the one or more linear functions.

11. One or more non-transitory computer-readable media storing instructions executable to perform operations, the operations comprising:
receiving an input value of a sigmoid linear unit (SiLU) activation function, the SiLU activation function decomposed into a first linear function and a nonlinear function, an input range of the SiLU activation function partitioned into a plurality of segments;
identifying a segment from a plurality of the segments based on the input value, the input value falling into the identified segment;
computing a first intermediate value by applying the first linear function on the input value;
retrieving, from a memory, parameters of a second linear function, the second linear function approximating the nonlinear function within the identified segment;
computing a second intermediate value based on the parameters of the second linear function and the input value; and
generating an output of the SiLU activation function based on the first intermediate value and second intermediate value.

12. The one or more non-transitory computer-readable media of claim 11, wherein the first linear function is a rectified linear unit activation function.

13. The one or more non-transitory computer-readable media of claim 11, wherein the memory is a sequential read-only memory.

14. The one or more non-transitory computer-readable media of claim 11, wherein the input value is negative, wherein computing the second intermediate value comprises:
applying the second linear function on an absolute value of the input value to compute an intermediate value; and
applying a negative sign on the intermediate value to compute the second intermediate value.

15. The one or more non-transitory computer-readable media of claim 11, wherein generating the output of the SiLU activation function comprises:
accumulating the first intermediate value and the second intermediate value.

16. The one or more non-transitory computer-readable media of claim 15, wherein generating the output of the SiLU activation function further comprises:
correcting an error in the second intermediate value.

17. An apparatus, comprising:
a computer processor for executing computer program instructions; and
a non-transitory computer-readable memory storing computer program instructions executable by the computer processor to perform operations, the operations comprising:
receiving an input value of a sigmoid linear unit (SiLU) activation function, the SiLU activation function decomposed into a first linear function and a nonlinear function, an input range of the SiLU activation function partitioned into a plurality of segments,
identifying a segment from a plurality of the segments based on the input value, the input value falling into the identified segment,
computing a first intermediate value by applying the first linear function on the input value,
retrieving, from a memory, parameters of a second linear function, the second linear function approximating the nonlinear function within the identified segment;
computing a second intermediate value based on the parameters of the second linear function and the input value, and
generating an output of the SiLU activation function based on the first intermediate value and second intermediate value.

18. The apparatus of claim 17, wherein the first linear function is a rectified linear unit activation function.

19. The apparatus of claim 17, wherein the input value is negative, wherein computing the second intermediate value comprises:
applying the second linear function on an absolute value of the input value to compute an intermediate value; and
applying a negative sign on the intermediate value to compute the second intermediate value.

20. The apparatus of claim 17, wherein generating the output of the SiLU activation function comprises:
correcting an error in the second intermediate value; and
accumulating the first intermediate value and the second intermediate value after correcting the error.
